(19) United States
(12) Patent Application Publication
(10) Pub. No.: US 2013/0283305 A1
(43) Pub. Date: Oct. 24, 2013

(54) SYSTEMS AND METHODS FOR A TELEVISION AND SET-TOP BOX APPLICATION DEVELOPMENT AND DEPLOYMENT PLATFORM

(71) Applicant: Media Direct, Inc., Deerfield Beach, FL (US)

(72) Inventors: Scott Hirsch, Boca Raton, FL (US); Sunny Rajpal, Sunrise, FL (US)

(21) Appl. No.: 13/842,109

(22) Filed: Mar. 15, 2013

Related U.S. Application Data
(63) Continuation-in-part of application No. 13/396,392, filed on Feb. 14, 2012.
(60) Provisional application No. 61/619,711, filed on Apr. 3, 2012.
(60) Provisional application No. 61/472,609, filed on Apr. 6, 2011.

(51) Int. Cl. H04N 21/485

(52) U.S. Cl. CPC H04N 21/485
USPC 725/14

(57) ABSTRACT

Systems and method are disclosed for providing a viewer environment on a television device. An authentication component permits a viewer to access a profile on a television device having a network connection, wherein the profile includes personalization data for customizing a viewer environment. The personalization data is derived, at least in part, from the viewer's interaction with the viewer environment. Access to the profile is granted in response to determining that the login credentials received from the viewer are valid. One or more customization aspects to be incorporated into the viewer environment are determined based on the personalization data in the profile. Data is provided for rendering the viewer environment on the television device of the viewer in a manner that includes the customization aspects associated with the personalization data.

### CROSS-REFERENCE TO RELATED APPLICATIONS

The present application claims priority to U.S. Provisional Patent Application No. 61/619,711 filed on Apr. 3, 2012 and U.S. patent application Ser. No. 13/396,392 filed on Feb. 14, 2012 which claims benefit to U.S. Provisional Patent Application No. 61/472,609 filed on Apr. 6, 2011. The present application is related to U.S. patent application Ser. No. ______ entitled “Systems and Methods for a Television and Set-Top Box Application Development and Deployment Platform” (Docket No. 0335558.001) which is being filed concurrently with the present application. All of these applications are incorporated herein by reference in their entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention generally relates to systems and methods for developing computer software applications. More specifically, certain embodiments are directed to systems and methods for developing, deploying and updating cross platform applications that can be accessed through televisions and similar media devices and that can be delivered through content delivery devices, including media devices such as Internet-capable televisions as well as set-top boxes (e.g., for cable and satellite systems) and streaming devices. These applications may be developed through an Internet-based or television-based application development and deployment platform that allows non-technical users and developers to build sophisticated, highly-customizable applications. In certain embodiments, the applications can be integrated with a viewer environment which provides for advanced interactivity between a user and television and further permits a user to personalize a viewing experience.

### BACKGROUND OF THE INVENTION

Much like with mobile applications, there has been an increasing proliferation of television applications (TV applications) as Internet-capable and smart televisions have become more popular. These may be referred to as connected televisions. Recently, consumers are increasingly relying upon these devices as an integral tool in the performance of a wide-range of personal and work-related tasks, beyond mere programming content delivery.

Numerous competing manufacturers and developers have entered the TV application space in recent years. This, in turn, has resulted in the development of a number of dissimilar and incompatible development/distribution platforms and environments. In fact, many of the common televisions, such as ones made by Samsung, LG, Panasonic, Sharp, etc. use different operating systems, many of which have their own programming environments and software development tools. In addition, certain content delivery devices such as set-top boxes (e.g., cable converter boxes) and streaming devices (e.g., Boxee) have their own developer interface to which applications may be submitted, reviewed and published.

Typically, developing applications for these different operating systems and devices requires the use of varying design techniques and programming languages, as well as separate operating systems or perhaps even device specific software code and compilations. As a result, it is often challenging for developers to write software applications that are portable across multiple types of televisions and similar media or content delivery devices. Developers who may wish to create TV applications that can run on different platforms would have to rewrite all or at least substantial portions of the software in order to support different devices.

Moreover, given the high level of skill and expertise needed to create, deploy and update TV applications, many non-technical individuals, as well as individuals lacking experience in a particular programming language, operating system or digital distribution platform, are not able to develop and/or distribute TV applications.

Certain providers facilitate the development and distribution of TV applications for certain types of operating systems and/or devices and distribute software development kits (SDKs) that are associated with their devices and/or operating systems (or particular versions or releases thereof). Among other things, these SDKs allow application developers to write programs or applications for users of the supported devices and/or operating systems. One example is Google TV, where TV applications may be developed using the Android SDK. These TV applications may be distributed through a Google Play Store distribution platform which may be accessible through a GoogleTV box (which is in turn connected to the user's television) or through a connected television with built-in GoogleTV functionality. In addition, different connected TV manufacturers provide their own SDKs whereby outside developers may create TV applications that are specific only to a particular TV platform.

Also, while these SDKs assist with the development of TV applications, in order to utilize these SDKs a significant degree of technical knowledge and expertise in software programming is typically required. In particular, use of these SDKs requires programmers to possess an understanding of and experience with both the programming language and the specific operating system platform for which the application is being developed.

Furthermore, while providers or manufacturers may provide SDKs to assist with the development of TV applications, they have not provided developers with a development platform that permits the developers to create or update TV applications directly using a television. Hence, a developer is unable to create or update TV applications on a device for which an application may be intended. Since the TV applications cannot be developed on the devices for which they may be intended, the creation, updating and testing of a TV application becomes more time-consuming and complicated.

In addition to the challenges associated with building TV applications, deploying these applications and distributing them to end users can often be a complex and involved process. In part, this is due to the fact that many of the television manufacturers and TV application distributors may require that all applications used with their devices and operating systems be distributed through their digital distribution platform or digital distribution platform (e.g., iOS's App Store, Android's Market, webOS's App Catalog, etc.). For example, while connected television manufacturers may share such platforms (e.g., the NetTV platform appears to be shared by Sharp and Philips), these platforms are generally different and incompatible. Also, the applications would likely have to be approved by the manufacturers or developers prior to being included in their distribution platforms. Obtaining such approvals for TV applications can be a time-consuming and complex process. As a result, an understanding of, and experience with, the requirements and restrictions imposed by manufacturers is often necessary in order to deploy and distribute applications to users successfully and efficiently. Similarly, a challenge exists in the area of updating or extending such TV applications, as this would also likely have to be done through their digital distribution platforms. These restrictions can further complicate and slow-down the distribution and management of TV applications.

Furthermore, additional problems may be associated with the accessibility of the TV applications and the environment associated with providing TV applications. For example, viewers may not know how to use their existing televisions to access TV applications. Alternatively, their television sets may not be Internet capable and would therefore require alternative ways of delivering TV applications to these more basic media devices, without needing to acquire additional hardware or connect to streaming devices (such as GoogleTV, Boxee or Roku). With respect to the viewer's environment, viewers may wish to tailor their viewing experience in accordance with their own likes, interests, hobbies and preferences. In addition, a viewer may wish to access the personalized viewer environment from any television, regardless whether or not the television is located in the viewer's household. Finally, the viewer may want to have personalized applications that they can access through their home televisions or on other televisions while on the road so as to enhance their viewing experience, while at the same time enabling them to stay connected with family and friends.

There is, therefore, a need for a system that simplifies and streamlines the development, deployment and updating of TV applications, thereby making the process accessible to non-technical users through an enhanced, user-friendly experience. There is also a need for a system that allows users to develop sophisticated, customized TV applications that can run on a variety of televisions or similar media devices as well as any set-top boxes or streaming devices and utilize a customized combination of operating system features and functionality. There is still further a need to provide alternative delivery mechanisms for TV applications, such that the applications may be delivered and updated through Internet-capable media devices such as internet-capable and smart televisions. There is still further a need for a system that provides users with updates associated with applications directly without the need to access digital distribution platforms. There is still further a need for a system in which cable/satellite network subscribers can personalize TV applications that they can access through their home televisions or on other televisions while on the road to enhance their viewing experience and stay up to date with developments that are of interest to them, while at the same time enabling them to stay connected with family and friends. There is still a further need to provide a development environment on a television that permits developers to create and update TV applications directly from the television. There is still a further need to provide a television viewer environment that provides for a high level of interactivity and permits a viewer to personalize settings associated with a viewing experience and access those settings from any television.

### SUMMARY OF THE INVENTION

One aspect of the invention is to provide a TV application development and deployment platform that allows developers to design, build, distribute and manage TV applications.

Another aspect of the invention is to provide such a platform that is accessible to non-technical users and operable through an easy-to-use, intuitive user interface that does not require users to possess expertise in computer programming or hardware.

Another aspect of the invention is to provide this platform directly on a television display to enable a developer to create and update TV applications directly via the television.

Yet another aspect of the invention is to provide such a platform that allows for a high degree of customizability/personalization and allows users to create sophisticated application through the customization and combination of various components, such as app-types, modules, content elements, and templates that can access features of various content delivery devices and their operating systems. Examples of such content delivery devices are media devices such as Internet-capable televisions as well as set-top boxes (such as cable or satellite television systems) and streaming devices (such as AppleTV, Boxee and Roku devices).

Another aspect of the invention is to provide a TV application development and distribution platform that is accessible through the Internet without the need for users to download or install any separate software, while enabling the applications developed through the platform to be accessible off-line.

Yet another aspect of the invention is to provide such a platform that allows users to build a single application that can be compiled for use across a wide range of content delivery devices and operating systems.

Another aspect of the inventive principles is to provide a TV application development and distribution platform that is accessible directly through the user's television.

Yet another aspect of the invention is to provide such a platform that manages the deployment and distribution through third-party digital distribution platforms of applications developed using the platform. Examples of such third-party digital distribution platforms for TV applications are the Google Play Store and the Boxee Application Directory.

Yet another aspect of the invention is to provide such a platform that allows applications to be assembled and updated on-the-fly through the use of configuration files that may be downloaded by end users and which include a reference to and/or subset of the application that is used to access application data from a remote source.

Yet another aspect of the invention is to provide such a platform that provides updates, content and other data associated with the application to users directly, without the need for users to reinstall the application or to download such updates, content or data from a digital distribution platform.

Yet another aspect of the invention is to provide a viewer environment that permits a viewer to customize settings associated a viewing experience (e.g., by selecting a set of TV applications, creating a personalized avatar, creating a list of contacts, setting up reminders, etc.) and access the customized settings from any television.

These and other features and advantages will become apparent from the following detailed description of illustrative embodiments thereof, which is to be read in connection with the accompanying drawings.

### BRIEF DESCRIPTION OF DRAWINGS

The inventive principles are illustrated in the figures of the accompanying drawings which are meant to be exemplary and not limiting, in which like references are intended to refer to like or corresponding parts, and in which:

FIG. 1A is a block diagram of an application development and distribution system in accordance with certain embodiments of the present invention.

FIG. 1B is a block diagram of an application development and distribution system in accordance with certain embodiments of the present invention.

FIG. 1C is a block diagram of an application development and distribution system in accordance with certain embodiments of the present invention.

FIG. 1D is a block diagram of an application development and distribution system in accordance with certain embodiments of the present invention.

FIG. 2 illustrates a detailed view of an application development platform in accordance with certain embodiments of the present invention.

FIG. 3 is method for creating or updating a TV application in accordance with certain embodiments of the present inventions.

FIG. 4 is method for providing a TV application to a viewer through a television in accordance with certain embodiments of the present invention.

FIG. 5 illustrates a block diagram of a system for providing a viewer environment in accordance with the certain embodiments of the present invention.

FIG. 6 is method for accessing a viewer environment on a television in accordance with certain embodiments of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

In accordance with the principles described herein, a software development platform is provided for creating or updating an application, or portion thereof. In certain embodiments, the software development platform may be integrated with or may use the ones described in U.S. patent application Ser. No. 13/396,392 filed on Feb. 14, 2012 and U.S. patent application Ser. No. 13/396,368 (now, U.S. Pat. No. 8,261,231) filed on Feb. 14, 2012, both of which are herein incorporated by reference in their entirety. For example, the principles disclosed herein with respect to creating or updating applications may be incorporated as a feature of the software development platforms described in these references, or may provide similar platforms to users for creating and updating applications. For example, in certain embodiments, the interfaces provided by the software development platforms described in these references may be utilized in conjunction with the principles disclosed herein to create or update applications. These interfaces may be provided to users through a television device or a personal computing device for developing television applications or other types of applications (e.g., mobile applications or web applications).

More specifically, in accordance with certain embodiments, a software development and distribution platform and corresponding arrangement may be provided that allows non-technical users and application developers to develop applications through the platform that may be built and compiled to run on multiple mobile operating systems and/or devices and utilize the various device and operating system specific features, without the need for programming knowledge or expertise. Certain of these embodiments allow users to highly customize the applications developed through the platform by selecting and combining various predefined components, features, application designs, and content and/or creating new components, such as app-types and modules. Certain embodiments allow users to deploy applications developed through the platform by submitting the compiled applications to digital distribution platforms associated with one or more types of operating systems and/or devices. Certain of these embodiments, allow the compilation to comprise an identifying reference and/or other basic information, rather than the application data itself, which may be used to retrieve application data from a remote source, and build and configure the application when end users download or execute the application. Certain embodiments allow users and developers to modify or update the applications and their content directly through the development platform.

In certain embodiments, a development and deployment platform and corresponding arrangements are provided to address concerns facing non-technical users and application developers, such as cross-platform interoperability, user-friendliness, customizability, and versatility. Certain embodiments allow non-technical users and application developers to create and update TV applications, without the need for technical knowledge and expertise, such as experience with computer programming. In certain embodiments, the platform may also be utilized to develop and update other types of applications, such as mobile applications, web applications, desktop applications, or any other type of application.

In certain embodiments, the application development platform may be provided to the user through a content delivery device, such as a television. A user may interact with the application development platform using an input device in order to specify commands for creating or updating applications. The commands may permit a user to customize application features, application modules and application templates that are associated with the application. A user may utilize a television remote control, a computing device that is connected to the television or set-top box, or other type of input device to specify the commands for customizing an application.

The manner in which the application development platform is provided to the user through a television may vary. In certain embodiments, the application development platform is stored on a server and the television and/or associated content delivery device (e.g., set-top box, streaming device, digital video recorder or other device in communication with the television) is connected to a network (e.g., the Internet) to enable access to the application development platform through a web browser on the television or by other means. In other embodiments, the application development platform is stored at a TV head-end and is accessible by the television and/or associated content delivery device via the television network (e.g., cable or satellite network). The application development platform may be accessible on a cable channel or other type of television network channel. In other embodiments, the application development platform is stored locally on the television or on an auxiliary content delivery device (e.g., set-top box, streaming device or other device in communication with the television) that may be connected to the television. In even further embodiments, the application development platform is distributed between the television (and/or content delivery device) and one or more of the server and/or TV head-end.

In other embodiments, the application development platform may be provided by a server (e.g., a web server connected to the Internet) which can be accessed by a user over a network with a personal computing device (e.g., desktop computer, laptop, tablet, mobile device, etc.). In other embodiments, the application development platform may be provided as an application on a user's personal computing device. In even further embodiments, the application development platform may be distributed between the server and a user's personal computing device. Thus, it should be recognized that any details disclosed herein which relate to providing an application development platform via a television device or an associated auxiliary content delivery device may also apply to providing an application development platform to a user via a personal computing device.

The application development platform may be utilized to assist users in creating and updating TV applications. In other embodiments, the application development platform described herein may be utilized to assist users with creating and updating of other types of applications, such as web applications, mobile applications, motor vehicle applications, and other types of applications.

In certain embodiments, the user may be presented with a set of tools that permit the user to customize features of an application, including features that relate to the functionality, design, and content of an application. Application data relating to the user-defined functionality, design, and content may be associated with the application and stored by development platform. The tools may include one or more application templates that assist a user with creating or updating an application. The application templates may be associated with a particular type of application for a business, hobby or other interest. For example, application templates may be provided for a restaurant, law firm, furniture store, photographer, musician, or any other type of application.

Each of the application templates may include one or more application modules that are associated with the particular application template. Each of the application modules may be associated with a particular interface or set of interfaces that are provided to the user, and may provide a particular type of functionality. For example, an application template for a furniture store may include separate application modules for providing a product listing interface that lists the available furniture, a shopping cart and/or check out interface that permits a user to purchase the items from the product listing interface, and a contact interface that displays contact information and a contact form that a user can fill out to transmit data to the furniture company. Users may customize various aspects of the application templates and application modules in order to create or update an application.

In certain embodiments, a user may create or update an application and customize application features relating to the functionality, content and design on an application without utilizing application templates. A user may select a subset of pre-constructed application modules that are to included in an application and then customize the features of the selected application modules. In some cases, a user may also be provided with a tool for designing an unique application module. The user may design a unique application module by selecting functional features, design features and content features that are to be provided by the application module. For example, the user may specify that an application module being designed should include both a contact form and a photo gallery, and should further include a first input field for specifying the title of the module and a second input field for specifying the description of the module. After the user is finished designing the application module, the user may access a customization interface for customizing the module (e.g., an interface that permits the user to customize the contact form, upload images to the photo gallery, and provide text in the two input fields).

An application format property may be received from the user indicating an application type for an application that is being created or updated by a user. The application format property may indicate an application type associated with a particular device, set of devices, or operating system that the application is intended to be executed on. For example, the application format property may specify that an application is intended to be executed by a particular Samsung smart-television or by a Google TV device.

In some cases, the user may specify the application format property after the user has finished customizing the application (e.g., after the user customizes the content or application modules associated with the application). The selections and application features associated with the application being constructed may initially be stored in a generic format for a generic application type. After the user has finished customizing the application, the generic application may be converted or translated to an application type associated the application format property that was specified by the user. In other embodiments, a user may specify an application format property before customizing selections and features for an application and the application development platform may directly create or update an application having an application type associated with the application format property.

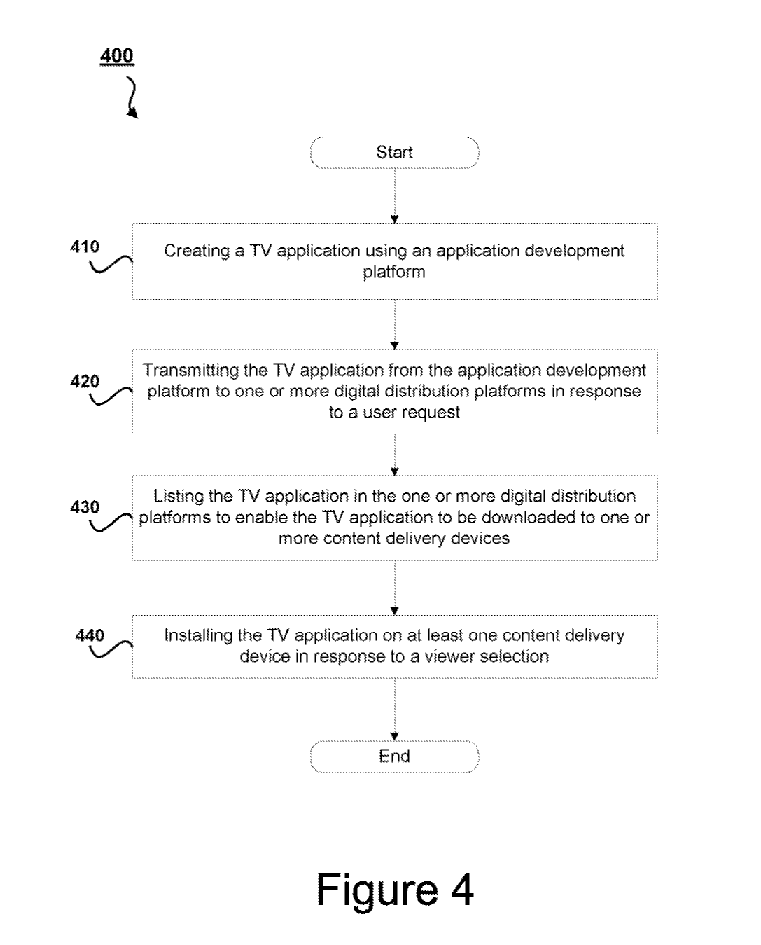

In certain embodiments, the generic application which is created or updated using a television device may be represented and/or stored using the exemplary data model described in FIG. 4 (along with the corresponding description of this figure in the specification) of U.S. patent application Ser. No. 13/396,392 and U.S. patent application Ser. No. 13/396,368 (now, U.S. Pat. No. 8,261,231), both of which are incorporated by reference in their entirety.

For example, in utilizing such a data model, the application components, design elements, contents, settings, and other data utilized by developers to design, create, modify, and customize applications through the development platform and corresponding systems and methods described and illustrated herein may be organized and stored in a relational and/or hierarchical manner. In certain of these embodiments applications developed through the platform may include and/or be represented by a set of application components, content element, and/or design elements, each of which, in turn, may include, or be associated with, one or more other application components, content elements, and/or design elements and so on. For example, each application may be associated with an app-type, which includes one or more modules, each of which, in turn, includes one or more layouts and one or more features.

In certain embodiments, the application components, design elements, content elements, and other data, as well as their relationships to each other, may be represented and stored in a database, such as relational database. In certain other embodiments, these relationships and the application data may be represented and/or stored in any other suitable format and/or medium, such as in tables, trees, sets of links, or other similar structures. By storing this information in a relational manner, applications developed through the development and distribution platform can be easily stored, retrieved, built, and updated simply by representing each application through a series of relationships between the application's components, elements and other data. Moreover, this data model or architecture enables new application components, content elements, and design elements created or customized by developers or other third parties to be added to the development and deployment platform and used by developers in the development of future applications.

In certain embodiments, compiled data may be generated for the application based on the features selected by user in creating or updating an application. A configuration file may be generated that includes an identifier for the application. The configuration file may be adapted for transmission to, and execution on, a content delivery device. The identifier may allow a content delivery device, such as a television, set-top box or other device, to retrieve at least a portion of the compiled application data in response to the application being installed on, or executed by, the content delivery device.

In certain embodiments, applications developed through the platform may be compiled using automated development frameworks (e.g., which may be associated with a software development kit to assist users with developing application) associated with the operating systems of the content delivery devices. In accordance with certain of these embodiments, the compilation may not contain the complete collection of data for the application, but instead may include an identifying reference and/or other basic information, such as a settings or configurations file and/or a subset of the application data. This information can later be used (e.g., when the application is downloaded, launched or executed by a user) to retrieve certain data associated with and/or utilized by the application including various components, modules, layouts, features, and content from a remote storage medium. The application may also use this information to check for and/or download any updates or modifications. In certain of these embodiments, the application may automatically check for and/or download such updates each time the application is launched.

The platform may further allow non-technical users and application developers to deploy TV applications (or other types of applications). Applications may be deployed to content delivery devices such as televisions, set-top boxes, or other auxiliary content delivery devices that are connected to a television and/or set-top box. Applications may also be deployed to a digital distribution platform. The digital distribution platform may permit applications to be downloaded and installed on content delivery devices. In some cases, a digital distribution platform may require an end user to purchase an application before the application is downloaded or installed. In certain of these embodiments, the digital distribution platform may require the application to go through an approval process prior to allowing the application to be deployed and distributed to end users via the digital distribution platform. The development platform may provide a function that submits an application to one or more digital distribution platforms for approval and distribution. In certain other embodiments, a user manually submit the application to the digital distribution platform (e.g., a user that has developed an application using the development platform may directly transmit the application to the digital distribution platform).

The application may be uploaded/downloaded to/from the development platform or a third-party application hosting service such as an digital distribution platform. The digital distribution platform may be located on a server connected to a network, such as the Internet, or at a TV head-end. In certain embodiments, after the application is downloaded and/or launched, the application may access one or more remote storage mediums to retrieve data relating to the features of the application (e.g., related to the content, design or functionality of the application), and display that data to the end user. In certain of these embodiments, the application data may be accessed from the development platform directly. In other embodiments, the application data may be accessed through an digital distribution platform or a third-party service. The application and/or content delivery device may cache certain application data retrieved from the remote storage medium. In certain of these embodiments, the application may determine whether the application should use this cached data or whether it should access the application data from the remote storage medium.

In certain embodiments, a viewer environment may be provided to one or more televisions in order to personalize the experience of a viewer. A profile associated with the viewer environment may be created for a viewer or household of viewers. The profile may include various types of data associated with a viewer or household (e.g., name, location, types of programs or TV shows the viewer prefers, hobbies, interests, channels the viewer likes, purchases made by the viewer, and various types of demographic information). The profile may be updated with information as the viewer or household interacts with the viewer environment Various aspects of the viewer environment may be personalized or customized for the viewer or household using the data in the profile.

The viewer environment may be personalized or customized in various ways using the data in the viewer profile. In certain embodiments, a viewer can customize a homepage interface associated with the viewer environment by selecting various widgets or applications to be integrated with the homepage interface (e.g., applications for displaying weather information, birthday reminders, RSS feeds, etc.). The homepage interface may further provide access to TV applications that have been purchased or downloaded by a viewer and communication tools that permit a viewer to communicate with others over the television network and other networks such as the Internet.

A viewer may access the personalized viewer environment and associated profile from remote televisions by entering login credentials to an authentication module. In certain embodiments, the authentication module may be provided over a television network by a TV head-end that is configured to provide the viewer environment to a viewer. In other embodiments, the authentication module may be provided over a network (e.g., Internet) by a server that is configured to provide the viewer environment to a viewer.

Embodiments described herein may be hardware-based, software-based and preferably comprise a mixture of both hardware and software elements. Thus, while the description herein may describe certain embodiments, features or components as being implemented in software or hardware, it should be recognized that any embodiment, feature or component that is described in the figures or description of the present application may be implemented in hardware and/or software. In certain embodiments, particular aspects are implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

### Exemplary Systems for Providing an Application Development Platform

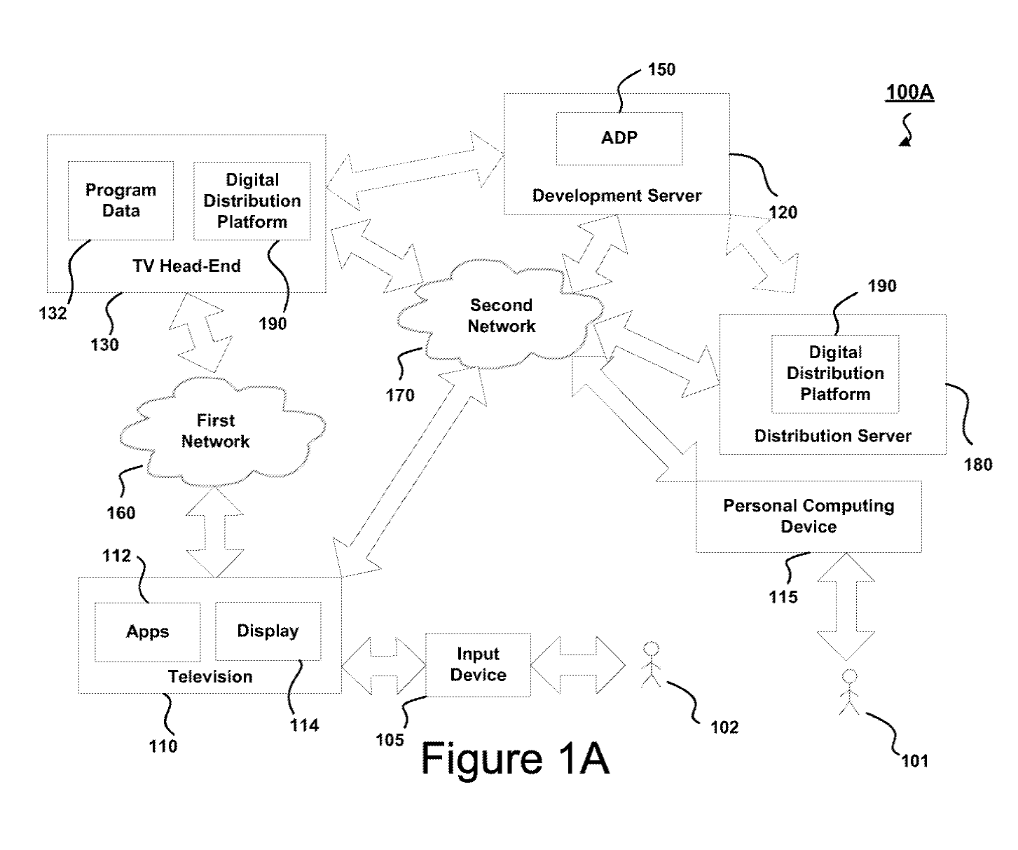

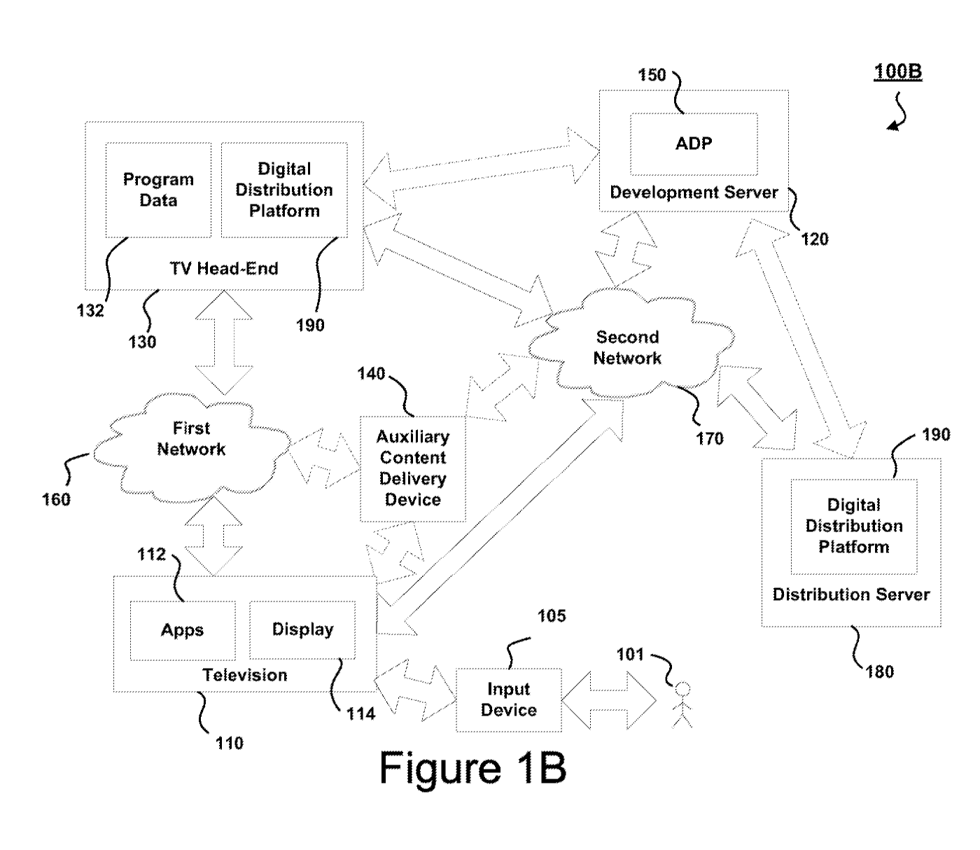

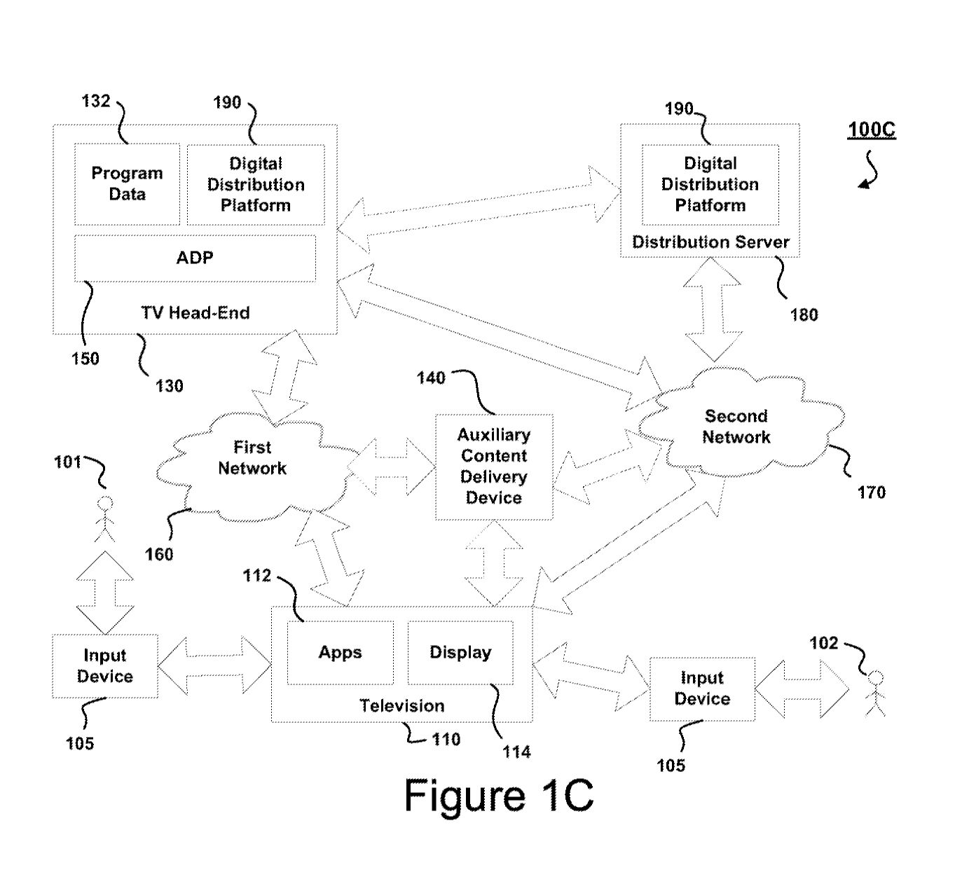

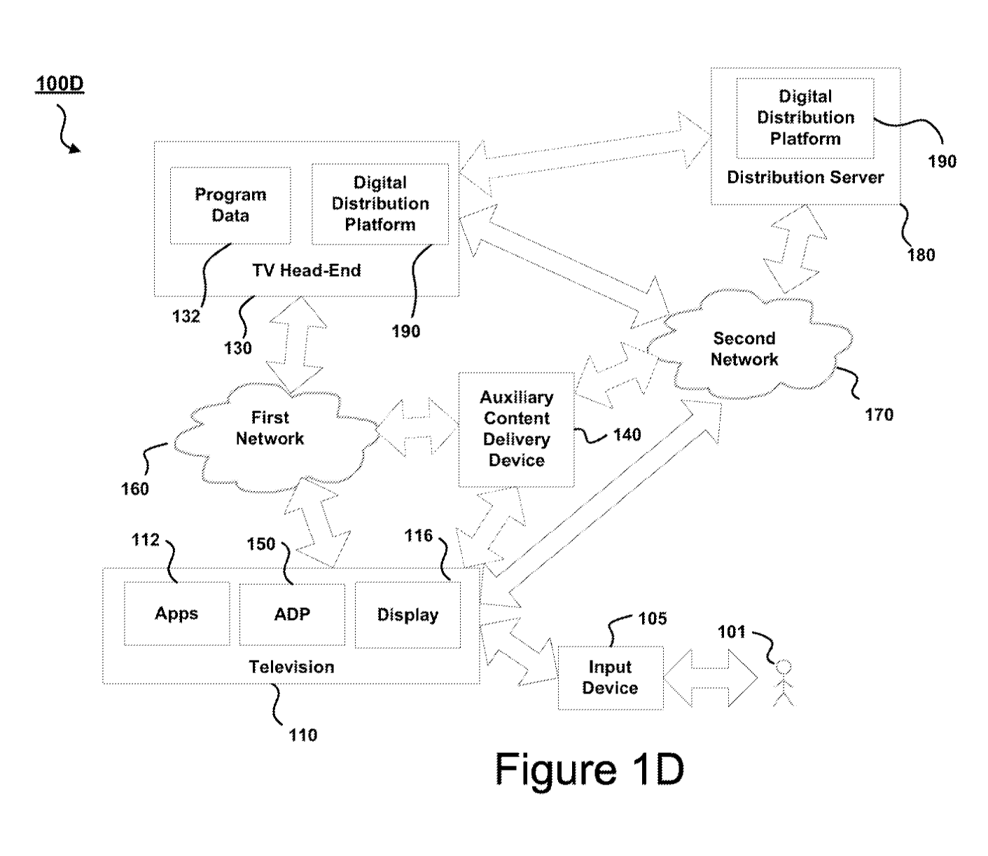

FIGS. 1A-1D illustrate exemplary systems for providing an application development platform to a user for creating, updating and/or distributing applications, such as TV applications. In certain embodiments, the application development platform (ADP) 150 can be provided to a user 101 on a personal computing device (e.g., as illustrated in FIG. 1A) that is connected to the Internet or other network 170. In other embodiments, the development platform 150 described herein can be provided to a user 101 directly on the user's television 110 (e.g., as illustrated in FIGS. 1B, 1C and 1D).

The exemplary systems illustrated in FIGS. 1A-1D disclose various components which may communicate with each other directly or indirectly through a first network 160 and/or a second network 170. The first network 160 and second network 170 may be any type of network such as one that includes the Internet, television network, a local area network, a wide area network, an intranet, etc. In preferred embodiments, the first network 160 may represent a television network (e.g., a cable television network or satellite television network) and the second network 170 may represent a network such as the Internet.

The components of the systems in FIGS. 1A-1D may communicate through any type of wired or wireless connection. The arrows indicate the presence of exemplary communication paths between the components and/or networks. The dashed arrows indicate the presence of optional or additional communication paths that may be included in certain embodiments. The input device 105, television 110, development server 120, distribution server 180, TV head-end 130 and auxiliary content delivery device 140 may each be equipped with one or more processing devices (e.g., a central processing unit) and one or more non-transitory computer-readable storage devices (e.g., RAM, ROM, PROM, SRAM, etc.).

Referring initially to FIG. 1A, an exemplary application development and distribution system 100A is disclosed. The system 110A includes an application development platform (“ADP” in FIGS. 1A-1D) 150 that enables a user 101 to create and/or update TV applications 112. The user 101 may represent an application developer, business owner, non-technical user or any other person who desires to develop a TV application 112. A user 101 may operate a personal computing device 115 to access an development server 120 over a second network 170 in order to create or update application using application development platform 150. The personal computing device 115 may represent a desktop computer, laptop, tablet, mobile phone, personal digital assistant or other type of computing device. As will be explained in further detail below with reference to FIGS. 1B-1D, the application development platform 150 also may be provided to a user 101 via a display 114 on a television 110.

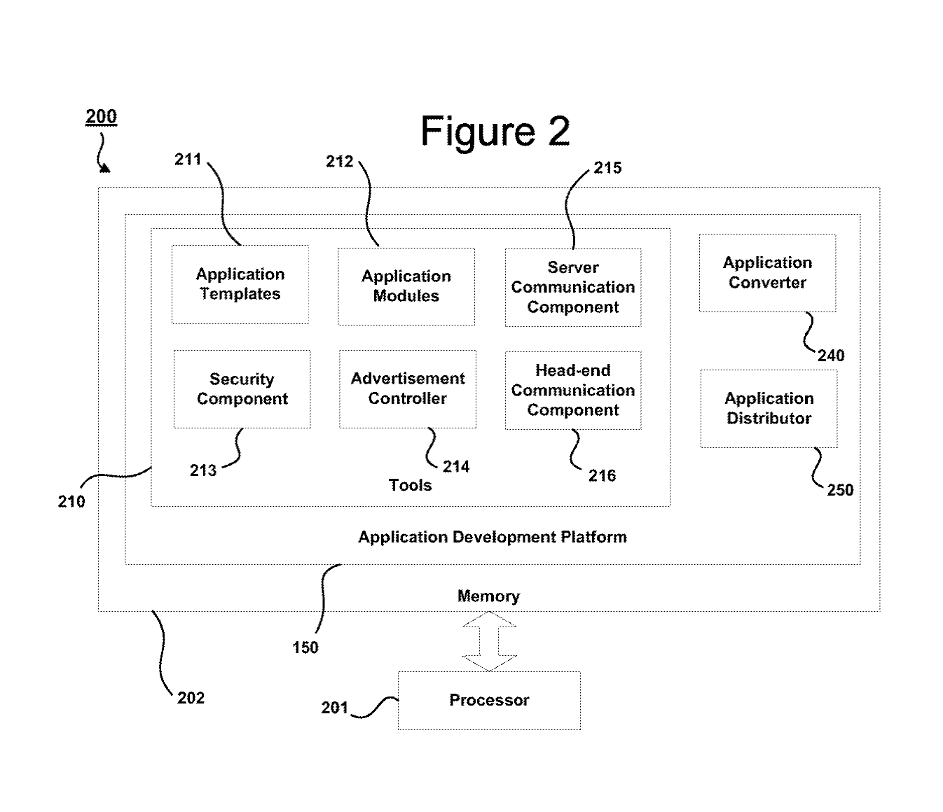

In certain embodiments, the application development platform 150 may be stored on a development server 120. The development server 120 may represent any type of computing device that can communicate over the second network 170. In certain embodiments, the development server 120 may include one or more mainframe computing devices that execute a web server. The development server 120 may be configured to provide the user 101 with an application development platform 150 that may assist the user with creating, updating and/or distributing TV applications 112. In certain embodiments, the application development platform 150 that may be configured to assist the user with creating, updating and/or distributing other types of applications such as mobile applications, web applications, motor vehicle applications, kiosk applications, desktop applications or any other type of application. In certain embodiments, the application development platform 150 may include architectures, tools, processes and/or data models which are the same or similar to those described in U.S. patent application Ser. No. 13/396,392, which is incorporated by reference herein in its entirety. FIG. 2, which is discussed in further detail below, illustrates an exemplary system 200 for providing an application development platform 150 that may be utilized to develop TV applications, or other types of applications, in accordance with certain embodiments of the principles described in this disclosure.

The application development platform 150 may permit users to create or update TV applications 112 that can be downloaded and/or installed on televisions 110. Nearly any type of TV application 112 can be created or updated utilizing the application development platform 150. Exemplary TV applications 112 may include gaming applications, multimedia applications (e.g., for displaying audio or videos), business-to-business (B2B) applications, distributed applications, applications for accessing an intranet, enterprise software (e.g., financial systems, customer relationship management systems and supply chain management software), accounting software, office suites (e.g., word processing applications, slide show applications, spreadsheet applications, etc.), multimedia editing software (image editing software, video editing software or audio editing software), media players, e-commerce applications, educational software, simulation software, engineering software (e.g., CAD software), and operating systems.

The application development platform 150 may enable a TV application 112 to utilize or incorporate program data 132 from a TV head-end over a first network 160. The program data 132 may include the actual programs (e.g., TV shows and movies) which are transmitted to the televisions 110, electronic programming guide data (EPG) and any other type of data which is made available by a TV head-end 130. The application development platform 150 may further enable a TV application 112 to utilize or incorporate data from one or more external servers that are accessible over the second network 170. For example, TV applications 112 created with the application development platform 150 may utilize databases, multimedia data (e.g., images, videos, audio recordings, etc.), social networking data or other data available on a server connected to the second network 170.

In certain embodiments, the TV applications 112 created or updated by the application development platform 150 may be downloaded and installed on a television 110 in response to inputs or selections provided by a viewer 102. In other embodiments, the TV applications 112 created or updated using the application development platform 150 may automatically be pushed to a television 110 or pre-installed on a television 110 (e.g., by a television manufacturer, provider of a television operating system, or other entity). Although the exemplary system 100A disclosed in FIG. 1A does not include an auxiliary content delivery device 140 as shown in FIGS. 1B-1D, it should be recognized that TV applications 112 may also be downloaded and installed to an auxiliary content delivery device 140 in a similar manner as discussed below.

The TV applications 112 created by the application development platform 150 may or may not be accessible to viewers 102. For example, in many cases, a viewer 102 may select a downloaded application, such as a web browser application or application for downloading movies, and interact with the application 112 directly. However, in other cases, the TV applications 112 may run in the background of a television or auxiliary content delivery device 140. For example, an application 112 may be running in the background of a television that tracks a viewers input and/or viewing habits, records the input provided by viewer, or utilizes the recorded information to customize the viewer's experience (e.g., customize advertisements, recommended programs, etc.).

In certain embodiments, the application development platform 150 may be configured to permit users to create and/or update TV applications 112 by utilizing application templates. The application types may be related to a particular type of business, organization, hobby, topic or purpose. For example, application templates may be provided for application types related to law firms, doctor offices, technology companies, engineering firms, educational institutions, website development companies, etc. Additional application templates may be provided for hobbies such as photography, sports team, book reading, cooking, fashion, clubs, etc.

Each application template may include one or more application modules that are associated with different interfaces (e.g., an interface describing services, an interface which provides a contact form, an interface for providing a shopping cart, etc.) and/or functional features. In order to create the application, the user 102 may customize global features for the application (e.g., select a name for the application, select a logo for the application, and indicate whether the application is to be configured for e-commerce) and populate the content of the application modules using input forms (e.g., which includes text input box, radio buttons, checkboxes, upload forms, etc.). The user may further select options for rendering interfaces associated with the application modules in high definition or in a three dimensional (3-D) format.

All of the user input may initially be stored in a generic format. When the user 102 is finished, the input provided by the user 102 may be convert into a particular application format that is compatible with a particular type of television 110 or other content delivery device (e.g., an auxiliary content delivery device 140).

A set of conversion templates may be utilized to convert the input provided by the user 101 into a TV application 112 having a format that is compatible with a particular content delivery device. Examples of such content delivery devices are media devices such as Internet-capable televisions, digital video recorders (DVRs), and DVD players, as well as set-top boxes (e.g., set-top boxes for cable or satellite television systems) and streaming devices (e.g., AppleTV, Boxee, Google TV, and Roku devices). In response to a user 101 selecting a target content delivery device for which a TV application 112 is to be executed, the application development platform 150 may retrieve a corresponding conversion template associated with selected content delivery device and convert the input provided by a user (e.g., input specifying the content, design and functionality of the application) into an application format that is compatible the content delivery device and/or the operating system associated with the content delivery device.

The conversion templates may account for and provide access to all of the features available on the content delivery devices and their operating systems. For example, suppose a television 110 was able to render content in high definition or in a three dimensional (3-D) format, and further included a Wi-Fi connection. The conversion templates associated with the device may include a library of pre-constructed modules or functions that can retrieved and populated with portions of the user input in order to utilize these features. Thus, the conversion templates may permit a user incorporate 3-D features or high-definition features into an application, or to access information or applications that are accessible on the Internet using a Wi-Fi or other network connection.

After a TV application 112 has been created, the application development platform 150 may assist users 101 in distributing the TV applications 112 to one or more digital distribution platforms 190. The application development platform 150 may include functions for distributing a TV application 112 to an digital distribution platform 190 located at a TV head-end 130 via first network (e.g., a cable or satellite television network) or to an digital distribution platform 190 located at a distribution server 190 via a second network (e.g., Internet). The digital distribution platforms 190 may provide a digital distribution service that permits developers to upload and/or sell TV applications 112 (or other types of applications) and viewers 102 to download and/or buy TV applications 112. Thus, the application development platform 150 may assist a user 101 in transmitting the TV application 112 to the digital distribution platforms 190, listing the TV application 112 in the digital distribution platforms 190, and/or submitting the TV applications 112 to one or more digital distribution platforms 190 for approval.

A distribution server 180 accessible over the second network 170 may provide an digital distribution platform 190. Like the development server 120, the distribution server 180 may represent any type of computing device that is capable of communicating over the second network 170. In certain embodiments, the distribution server 180 may represent one or more computing devices (e.g., one or more mainframe server devices) that execute a web server.

The distribution server 180 or digital distribution platform 190 may be associated with a device manufacturer and/or operating system provider. For example, a TV manufacturer (e.g., Samsung, LG, Sony, etc.) or manufacturer of a content streaming device (e.g., GoogleTV or AppleTV) may provide a digital distribution platform 190 which permits viewers 102 to download TV applications 112 to televisions 110 manufactured by the manufacturer. In other examples, the digital distribution platform 190 may be provided by a distribution server 180 associated with a provider of a television operating system. For example, a single television operating system provider may provide an operating system that is utilized by several different types of televisions 110 (possibly across a variety of different television 110 manufacturers) and which facilitates the execution of TV applications 112 on the associated televisions 110. Such a provider may also be the source of a digital distribution platform that includes TV applications 112 that can be executed on all or some of the devices that include the operating system.

A digital distribution platform 190 may also be provided by a TV head-end 130 associated with a television provider (e.g., Time Warner Cable, Verizon Fios, Optimum, DirectTV, Comcast, etc.). Generally speaking, the TV head-end 130 may represent a facility associated with a cable television provider or satellite television provider that receives televisions signals (or channels), processes the signals and/or distributes the signals to a plurality of televisions 110 (or other content delivery devices). The TV head-end 130 may provide the digital distribution platform 190 to the televisions 110 of viewers 102 via a first network 160.

Although it is not depicted in FIGS. 1A-1D, the development server 120 may also include an digital distribution platform 120. For example, the development server 120 may be configured to automatically list TV applications that have been created and published using the application development platform 150. Thus, in certain embodiments, the development server 120 and distribution server 180 may represent a single component of the system.

A viewer 102 may utilize an input device 105 to download and/or purchase TV applications 112 from the TV head-end 130 over the first network 160 or from a distribution server 180 over the second network 170. In certain cases, the TV applications 112 selected by a viewer 102 may not actually be downloaded to the viewer's television 102 or associated content delivery device. Rather, the TV applications 112 selected by the viewer 102 may be stored and executed at the TV head-end 112 or external server, and the output may be transmitted to and displayed on a viewer's television 110. After a TV application 112 is installed on a television 110 or otherwise made available to a viewer 102, the input device 105 may also be utilized to interact with the TV application 112. For example, the input device 105 may be used to interact with a gaming application 112 or to navigate through interfaces of an application 112.

FIGS. 1B-1D illustrate alternative systems for providing an application development platform 150 to user 101 in accordance with certain embodiments. Rather than providing users 101 access to the application development platform 150 via a personal computing device 115, the systems illustrated in FIGS. 1B-1D may provide an application development platform 150 to the user 101 via a display 114 on the television 110 in order to permit the user 101 to create, update and/or distribute TV applications (or other types of applications) directly from a television 110. The user 101 may utilize an input device 105 (e.g., remote control, keyboard, microphone, etc.) to interact with the application development platform 150 for the purpose of creating, updating and distributing applications, such as TV applications 112. The input device 105 may represent a television remote control, laptop, tablet, touch screen device, smart phone, keyboard, joystick, desktop computer, microphone, or any other type of wired or wireless input device.

As shown therein, the user's television 110 may be connected to a first network 160 (e.g., a television network), a second network (e.g., the Internet), or both. The television 110 may connect to these networks using any type of wired or wireless connection. Rather than directly connecting to the first network 160 or second network 170, the television 110 may utilize an auxiliary content delivery device 140 to connect to the first network 160 or second network 170 in certain embodiments. Thus, the auxiliary content delivery device 140 may be utilized to permit the television 130 to communicate with the TV head-end 130 or server connected to the second network 170. This type of configuration may be useful for embodiments in which the television 110 is not equipped with an appropriate network connection (e.g., Wi-Fi connection) due to hardware and/or software limitations of the television 110. The auxiliary content delivery device 140 may represent any type of device that is capable of connecting the television 110 to the first network 160 or second network 170. Exemplary auxiliary content delivery devices 140 may include a set-top box, streaming device, digital video recorder, DVD player, external Wi-Fi component, Google TV device, Apple TV device, etc. In certain embodiments, the input device 105 may be configured to communicate with the auxiliary content delivery device 140.

It should be recognized that any functionality or feature discussed in this disclosure which relates to a television 110 can alternatively be included on or performed by an auxiliary content delivery device 140, or jointly between the television 110 and the auxiliary content delivery device 140. Likewise, for the purposes of this disclosure, any known functionality of an auxiliary content delivery device 140 (e.g., communicating with a TV head-end 130, decoding signals, communicating with input devices, etc.) may be performed by the television 110.

As illustrated by FIGS. 1B-1D, the location of the application development platform 150 may vary in different embodiments. In certain embodiments, the application development platform 150 may be provided by one or more development servers 120 that are in communication with the television 110 through a second network 170 which is separate from the network 160 that provides television program data 132 to the television 110 (e.g., see FIG. 1B). In other embodiments, the application development platform 150 may be provided by one or more TV head-ends 130 which are in communication with the television 110 through a television network (e.g., see FIG. 1C). In even further embodiments, the application development platform 150 may be provided locally on the television 110 (e.g., see FIG. 1D).

Each of the configurations shown FIGS. 1B-1D may be particularly useful depending upon certain characteristics or limitations that may be present in the system and/or network associated with providing the application development platform 150. For example, consider the exemplary application development and distribution system 100B shown in FIG. 1B. In this system 100B, the application development platform 150 is located on a development server 120 that is communication with the television through the second network 170 (e.g., Internet). This may be preferable when the television 110 is connected to a television network (e.g., the first network 160) that is configured for one-way communication (e.g., a typical satellite television network). Given that the television 110 may be unable to transmit data back to a TV head-end 130 in a one-way communication television network, it may not be preferable to locate the application development platform 150 at the TV head-end 130. Thus, providing the application development platform 150 on a server 120 which is accessible over a second network 170 (e.g., Internet) that is separate from the television network may be preferable in this case.

Even if a television network is configured for two-communication and the user 101 is able to transmit data back to the TV head-end 130, the system 100B in FIG. 1B may still be preferable since the bandwidth allocated to each television 110 by a television program provider is typically limited in comparison to the bandwidth that may be available through a Wi-Fi, or other type of connection (e.g., Ethernet), to the second network 170. Thus, a user 101 may experience reduced latency and be able to transmit larger amounts of data more quickly utilizing the connection to the second network 170

The exemplary application development and distribution system 100C illustrated in FIG. 1C may also be preferable in certain embodiments. In this system 100C, the application development platform 150 is provided by the TV head-end 130 to the user 101 via the first network 160, which may represent a cable television network in some cases. This configuration may be preferable in the case that a user's television 110 is unable to connect to the second network 170 (e.g., if the user's residence does not have access to the Internet). Moreover, even if the user's television is able to be connected to the second network 170, this configuration may still be preferable in cases where the bandwidth allocated to the television 110 (or set-top box) is adequate for communicating with the TV head-end 130.

FIG. 1D illustrates another exemplary application development and distribution system 100D in which the application development platform 150 is located locally on the user's television 110. In this system, the user 101 may not be connected to either the first network 160 associated with the TV head-end 130 or the second network 170 associated with a development server 120 in order to create or update an application. Thus, this system 100D may be preferable because the user does not have to purchase access to either the first network 160 or second network 170 in order to create an application of the television 110. This system 100D may also be preferable because the user 101 will not experience latency associated with the transmission of communications over the first network 160 or second network 170.

In certain embodiments, the systems 100B and 100C in FIGS. 1B and 1C may be preferable over the system 100D in FIG. 1D for reasons associated with maintaining or updating the application development platform 150. For example, suppose that a provider of the application development platform 150 wishes to update or modify the functionality of the application development platform 150. If the application development platform 150 was located at either a TV head-end 130 or development server 120, these maintenance operations can be performed at a single location. However, if the application development platform 150 was located on the actual televisions 110 of the users 101, the maintenance operations may require the provider of the application development platform 150 to transmit the updates to each of the televisions 110 that include a local copy of the application development platform 150. This may be an issue for numerous reasons. For example, the televisions 110 may be temporarily disconnected from either the first network 160 and/or second network 170, and thus unable to receive the updates. In other cases, the bandwidth required to propagate the updates to each of the televisions 110 may place a great burden on the network due to downstream bandwidth limitations, thus causing increased latency across the entire network. Therefore, in cases where maintenance operations are expected to be performed periodically or routinely, it may be preferable to locate the application development platform 150 at a centralized location such as the TV head-end 130 and/or development server 120.

While FIGS. 1A-1D demonstrate a few examples of how a system may be configured to provide an application development platform 150 to a user 101, it should be recognized that these systems can be varied in many different ways without departing from the scope of the present principles. For example, in certain embodiments, the application development platform 150 may not be located on the TV head-end 130, development server 120, personal computing device 115, or the television 110. Rather, the application development platform 150 may be provided by an external device (e.g., possibly the auxiliary content delivery device 140) connected to the television 110 and/or personal computing device 115.

Furthermore, although it is not shown in FIGS. 1A-1D, the application development platform 150 may be distributed across two or more components of the system. For example, in certain embodiments, the television 110 and/or personal computing device 115 may include a front-end portion (e.g., a locally running client application) of the application development platform 150 that works in conjunction with back-end portion of the application development platform 150 which is stored on the server 120 and/or TV head-end 130. In certain cases, the front-end portion of the application development platform 150 may be configured to handle the tasks that can be performed with the limited resources of the television 110 or personal computing device 115, while the back-end portion of the application development platform 150 located on the server 120 and/or TV head-end 130 may be allocated the tasks that require heavy processing.

Furthermore, although the disclosure herein primarily discusses the creation of TV applications, it should be noted the application development platform 150 described herein can be configured to create, update and/or distribute nearly any type of application, including mobile phone applications, web applications, motor vehicle applications (e.g., which can be accessed through a display device in a vehicle), airplane applications (e.g., which can be accessed by a display device that is presented to airline passengers), kiosk applications and desktop applications. For example, in the case that the application development platform 150 is being utilized to create airplane applications, the television 110 illustrated in FIGS. 1A-1D may be substituted with a display device or computing device provided to passengers on an airplane. Similarly, the first network 160 may substituted for a private network associated with a company which provides service to the airplane display device (e.g., a network associated with Inmarsat's SwiftBroadband service or a network associated with Gogo's Inflight Internet Service) and the TV head-end 130 may be substituted with a satellite access station or head-end associated the company.

Other types of variations and/or modifications are also be incorporated into the systems illustrated in FIGS. 1A-1D.

### Application Development Platform

FIG. 2 illustrates an exemplary system 200 for providing an application development platform 150 in accordance with certain embodiments. As shown therein, the system comprises at least one memory device 202 (e.g., RAM, ROM, PROM, SRAM, etc.) and at least one processor 201 (e.g., central processing unit) which are in communication with each other (e.g., via a system bus or by other means). Preferably, the memory device 202 may represent a physical, non-transitory storage medium. The application development platform 150 may be comprised of various functional software components that are stored on the memory device 202.

It should be noted that although the components on the memory device 202 may be described throughout this disclosure as software modules, such is not necessary. Rather, the components may be implemented in software, hardware or any combination of software and hardware. Furthermore, while the components may be illustrated as separate and distinct components, it should be recognized the components can be combined in a variety of different ways (e.g., all of the components may be executed as a part of a single program or as separately executing processes or threads). In addition, the functions performed by these components may overlap in some instances. For example, in certain embodiments, the functions performed by the security component 213, advertisement controller 214, server communication component 215 and head-end communication component 216 may be included or incorporated into the application templates 211 and/or application modules 212.

As shown therein, the application development platform 150 may include a set of tools 210. The tools 210 may generally include an function that permits a user to create and/or update TV applications 112 or other types of applications. As explained in further detail below, the tools 210 may be utilized by a user 101 to customize an assortment of application features for both TV applications 112 and other types of applications. For example, the tools 210 may permit a user 101 to add or update the functionality, interface design, content (e.g., text, images, video, audio, etc.), security features, and/or advertisements of an application. A user 101 may design interfaces and specify colors, logos, links, buttons, content (e.g., images, video, audio, etc.) and other data that is presented on the interfaces on a TV application 112. The tools 210 may further permit a user 101 to select from a variety of functional features and to incorporate the functional features (e.g., forms, RSS feeds, scrollers, calendars, shopping carts, etc.) into the TV application 112. Other types of applications features may be customized using the tools 210 as well.

In certain embodiments, a user may select one or more application templates 211 to be associated with the TV application 112. In some cases, the application templates 211 may be provided for a particular type of business, organization, hobby or purpose for which an application is intended. For example, application templates 211 may be provided to assist a user 101 in creating a TV application 112 associated for a particular type of business such as a law firm, doctor office or accounting firm, or may be associated with a particular purpose or hobby such as photography, dining menus, or amateur sports team.

Each application template 211 may include a particular set of application modules 212 that are associated with the application template 211. Each application module 212 may be associated with creating or updating one or more interfaces for a television application 112 that include functional features, design features and content features. A user may customize the application templates 211 by adding or deleting application modules 212. The user 101 may further customize application templates 211 by adjusting global settings for the application being created or updated. For example, a user 101 may specify a name for the application, upload a logo for the application, and select color schemes, interface layouts or other design features that should be applied to the interfaces of the TV application 112 (e.g., which should be applied to the interfaces associated with the application modules 212).

As mentioned above, each of the application modules 212 may assist a user 101 with creating or updating the functionality, design and content of one or more end-user interfaces (e.g., interfaces that are display to end-users who download and install the application on televisions or other content delivery devices). Exemplary application modules 212 may permit a user to create or update a contact information interface, shopping cart interface, checkout interface, an interface that describes a company, an interface that lists products or services, an interface for providing an image or video gallery, an interface for providing online auction, an interface for providing a login form, an interface for providing account management system, an interface for creating an event calendar, an interface for uploading data to a server, etc.

Each application module 212 may be associated with one or more customization interfaces that permit a user 101 or developer to create or update features of a television application 112 (e.g., application features that relate to the functionality, design and content of the application module) that may be provided on the end-user interfaces. For example, a list of application modules 212 associated with an application template 211 may be displayed to the user and the user may select an application module 212 to access a customization interface associated with the application module 212. The user may specify customization selections (e.g., by providing text in input fields, clicking check boxes, selecting items form a list, uploading multimedia data or other data, etc.) in order to customize the functionality, design and content of the application module 212 and the end-user interface associated with the application module 212.

Each of the application modules 212 may include one or more functional features that can be customized by the user 101. For example, the application module 212 associated with providing a contact information interface may include a contact form that can be customized by the user 101 to permit customers to submit information, while the application module 212 associated with the photo gallery interface may include a photo gallery that allows a user up upload images to be displayed to customers. Likewise, the application module 212 associated with the shopping cart interface may include a shopping cart for purchasing products or services, while the checkout page includes a form for accepting and processing a customer's credit card information. Application modules 212 can be included to assist a user 101 with incorporating nearly any application feature into a TV application 112.

Each of the application templates 211 may include a predetermined set of application modules 212. A user 101 may browse through and select any application module 212 that is included in a TV application 112 in order to customize the content of the application module 212 (e.g., text, images, videos or other multimedia). In addition, a user 101 may choose to delete any of the application modules 212 that are included in an application template 211 or to add additional application modules 212 (e.g., by selecting the application modules 212 from a list). For example, a user 101 may be permitted to browse through and select a variety of different application modules 212 that can be incorporated into an application 112. The application modules 212 may permit the user 101 to create interfaces for a contact form, a shopping cart, a listing of products and services, image or video gallery, an online auction function, login form, an account management system, a payment form for accepting credit card processing, creating an event calendar, uploading data to a server, etc. In fact, nearly any type of application module 212 may be included in the library that assists a user 101 in creating and/or updating a TV application 112.

Users 101 may customize the functional features of the modules 212. For example, in the case of a contact form, the user 101 may specify the names of input fields on a contact form (e.g., name, address, email, comments, etc.) and may specify an email address that should receive the contents of the form in response to a viewer 102 or other person filling out the form. As another example, if the user is incorporating an application module 212 for uploading files, the user may specify a directory (e.g., URL) where the files should be uploaded and may further specify the types of files that may be uploaded (e.g., the user 101 may specify that only PDFs or image files may be uploaded to the directory by selecting appropriate checkboxes or radio buttons).

Depending upon the type of TV application 112 that is being constructed, the user 101 may select the application modules 212 which are useful to be incorporated into the TV application 112. The application modules 212 facilitate the creation of applications by non-technical users 101 since the users 101 are not required to write the program or code associated with each of the functions or have any programming or technical knowledge.

In certain embodiments, the tools 210 may also allow a user 101 to select one or more design templates to be applied to interfaces associated with an application module 212 or application template 211. The design templates may provide a basic design or outline for an interface or set of interfaces that are associated with the application 112. For example, the design templates may specify the location and/or appearance of navigation menus, links, forms, buttons, logos, title of the application, etc. Users 101 may be permitted to adjust the default settings for a design template in order to customize the appearance and design of an interface associated with a TV application 112. Users 101 may also upload content to be incorporated into the design of a TV application 112.

Consider an exemplary application template 211 that may be provided for a photography application. A photography application template 211 may enable a non-technical user 101 to quickly create a TV application 112 for displaying photographs and selling photographs. To this end, the application template 211 for the photography application may be associated with a variety of application modules 212 including a module 212 for displaying a photo gallery to a viewer, a module 212 that enables the users to add new photographs that are to be listed for sale, a module 212 that permits a viewer to add photographs to a shopping cart in order to be purchased, a module that provides a checkout page for purchasing photographs, and a module 212 that describes the photography company.

Each application module 212 may also be associated with one or more customization interfaces that permit a user 101 to customize functional features, design features and content features associated with the module 212. For example, the application module for displaying a photo gallery may include a functional feature that provides a gallery for displaying photographs and which permits viewers 102 to browse the gallery and select photographs for viewing. The user 101 designing the application 112 via the application development platform 150 may customize the appearance of the gallery (e.g., by selecting how many rows or columns should be displayed), upload photographs to populate the content of the gallery, provide textual descriptions of the photographs, and alter design features relating to the appearance of the photo gallery interface (e.g., change color schemes for the interface, adjust the location of menus on the interface, etc.).

The photography template is just one example of an application template that may be utilized. It should be recognized that application templates may be provided for nearly any type of business or purpose. Appropriate modules can be constructed and added to the templates which are tailored to the business type or purpose of the application.

As another example, an entirely separate application template may be provided for an application dealing with a law firm. This application template 211 may be associated with application modules for providing a homepage interface provides some basic information about the law firm, a practice area interface which describes the services provided by the law firm, and a consultation page interface that permits potential clients to fill out a form in order to schedule a consultation with an attorney. The user 101 may select the application modules 212 associated with each of these interfaces to customize the application modules 212 and corresponding interfaces. For example, a user 101 may provide a textual description and upload images to populate the contents of the homepage module and practice areas module. For the consultation page module, the user may also provide some input to specify the fields that may be included on the consultation form and an email address that is to receive the contents of the form. After the user 101 provides these customization selections which requires no programming knowledge, a TV application 112 may be created in a particular format that is specified by the user 101 as explained in further detail below. Thus, a non-technical user 101 is able to create and customize TV application 112 by providing basic input (e.g., by filling out forms and uploading content) and without requiring any programming or technical knowledge.

It should be recognized that a user may create or update an application without utilizing application templates. In certain embodiments, a user may personally select a set of pre-constructed application modules that are to included in an application and then customize the features of the selected application modules. In certain cases, a user may presented with a list of application modules. The user may then select one or more application modules that are to be included in the television application 112. For example, a user may select (e.g., by clicking a checkbox for each selected module) a product/service description module, a photo gallery module, a contact form module, and a RSS feed module (e.g., which permits a user to provide an RSS feed via the television application) to be included in the application 112. After the selecting the modules, the user may then customize the functionality, design, content and other features of the modules.

In certain embodiments, a tool 210 may be provided for creating or designing an new application module 212. A user 101 may select the functional features, design features and content features that are to be provided by the application module 212. For example, the user may specify that an application module 212 being designed should include functional features such as a contact form and an event calendar, and should further include several different textual input fields (e.g., input field for specifying the heading of the module, an input field for specifying a description of the module, and input field for specifying other information). The user may also design the layout of the module (e.g., by specifying where menus, hyperlinks headings and other features are located). Once the user is finished designing the application module 212, the user may access a customization interface which permits the user to populate or customize the contents of the newly created module that has been designed by the user (e.g., an interface that permits the user to customize the contact form, event calendar, and input fields that the user selected).

There may be certain cases where an application module 212 is not provided for a particular a function that a user 101 wishes to incorporate into a TV application 112. Therefore, the tools 210 may also permit a user 101 to incorporate custom functionality into a pre-constructed application module 212 or an application module 212 that is being designed by a user. In certain embodiments, a user 101 having programming experience may create a program or script to provide the customized functionality and the program or script may be incorporated into the module (e.g., by uploading the program or script or by inputting the program or script via an input form). The tools 210 may permit the user to associate the custom functions with particular objects (e.g., forms, links, etc.), content (e.g., image, text, video, etc.) and/or events (e.g., onmouseover event, onclick event, etc.) in order to easily integrate the functions into the application modules 212.

Moving on, the tools 210 may further include a security component 213. The security component 213 may permit a user 101 to limit access to an application or a portion of an application that is being created and/or updated. For example, the security component 213 may permit a user 101 to protect access to an application or portion of an application using a password. Thus, a viewer 102 attempting to execute a TV application 112 stored on a user's television 110 may be required to enter a password before the application would be launched. Rather than preventing access to a program entirely, a password may be utilized to protect access to certain portions of a program.

The security component 213 may also incorporate various types of parental controls into a TV application 112. For example, a TV application 112 can be designed using the security component 213 such that a viewer 102 who downloads and installs the TV application 112 on a television 110 can customize the content which is presented by the application. For example, suppose a viewer 102 downloaded a TV application 112 from an digital distribution platform 190 that provided on-demand access to independent films, and the TV application 112 was installed on the viewer's television. Further suppose that the viewer 102 had a young child and did not want to the child to view any independent films that may be inappropriate for young children. To limit the type of content which was accessible through the TV application 112, the viewer 102 may access a set of parental controls which are provided as part of the application. The application may permit the viewer to filter content based on TV rating (e.g., TV Y, TV G, TV PG, TV MA, etc.) similar to the functions performed by a v-chip, or filter the content based on other criteria (e.g., by explicitly identifying the programs which are inappropriate).

In certain embodiments, the tools 210 may further include an advertisement controller 214. The advertisement controller 214 may be configured to control various aspects of managing the presentation of advertisements in a TV application 112. The advertisement controller 214 may incorporate functionality into a TV application 112 that permits the TV application 112 to determine whether or not advertisements should be displayed to a viewer or subset of viewers. In certain cases, the advertisement controller 214 may incorporate features into a TV application 112 that determines whether a viewer has paid a subscription or fee that permits the viewer to avoid advertisements. The advertisement controller 214 may also permit a user 101 to configure the frequency at which advertisements should be displayed (e.g., every ten minutes an advertisement should be displayed), or to specify that advertisements are to be displayed upon the occurrence of certain events (e.g., if a new level is reached in a gaming application).

The advertisement controller 214 may further permit a user to incorporate advertisements from one or more sources into a TV application 112. For example, in certain cases, the advertisements displayed by a TV application 112 may be stored and/or retrieved from a development server 120 (e.g., if the user 101 creating the application has uploaded them to the server in creating or updating the TV application 112) or from an external server associated with an entity or business (e.g., a business which has paid for insertion of the advertisement). In other embodiments, advertisements may be stored and/or retrieved from a TV head-end 130 or from program data 132 provided by a TV head-end 130. The advertisement controller 214 may permit a user to identify advertisements to be incorporated into a TV application 112 by specifying a URL or network address that indicates the location of the advertisement or by uploading the advertisements to a development server 120 or other server that is accessible over the second network 170. Any advertisements retrieved from any of the sources mentioned above, or other sources, may be downloaded and/or stored on a television 110 before being displayed.

In certain embodiments, the advertisement controller 214 may incorporate functionality into a TV application 112 which determines the advertisements that are to be displayed to a particular user or subset of users, or which determines the relevancy of particular advertisements to a particular user or subset of users. For example, the advertisement controller 214 may permit a user to customize the presentation of advertisements to television viewers or households based on demographic information, or other information that is descriptive or associated with a viewer or household. The demographic information may include data which provides information about a viewer and/or household including age, gender, martial status, ethnicity, race, religion, educational background, income, job, location, citizenship, interests (e.g., sports, cooking, business, technology, books, magazines, etc.), purchases made by a viewer (e.g., purchases made by a viewer via the television 110), etc. Nearly any information that describes a viewer or household can be utilized as demographic information that is considered in determining appropriate advertisements for display to the viewer or household.

It certain embodiments, the functionality performed by the advertisement controller 214 permits a TV application 112 to generate profiles for a viewer 102 or household that include the demographic information for the viewer or household. The advertisement controller 214 may configure the TV application 112 to utilize the data in the profiles to determine which advertisements should be displayed to particular users. Thus, the advertisement controller 214 may incorporate functionality into the TV application 112 that enables the TV application to tailor the advertisements to a particular viewer 102 or household. This may be done, at least in part, by associating particular advertisements with categories (e.g., sports, cooking, technology) and correlating the categories to data in a profile for a viewer 102.

For example, the TV application 112 may utilize the correlations to determine whether it is appropriate to display a particular advertisement relating to toys because a profile associated with household indicates that the household has a child of young age. Likewise, it may be determined that it is inappropriate to display an advertisement that relates to feminine care products in cases where the profile indicates that the viewer is a male. Thus, based on the input provided by a user to the advertisement controller 214, the user 101 can control and manage the display of advertisements that are presented via the TV application 112 (e.g., by associating particular advertisements with the profile data).

It should be noted that the manner in which the demographic information is collected or provided may vary. In certain cases, the demographic information may be retrieved from a TV head-end 130, or from an external server. In other cases, the tools 210 may permit the user to configure the TV application 112 in a manner which able to collect the demographic information. For example, the TV application 112 may be configured to collect explicit input provided by a user (e.g., if a viewer fills out a form in which the viewer provides feedback that indicates age, gender, interests, etc.) or implicit input provided by the user (e.g., by monitoring or tracking the television programs watched by the user, products ordered by the user via the television, the duration that a viewer watches a particular program or advertisement, the frequency at which a user watches a particular channel, etc.).

In addition, as will be discussed in further detail below, a viewer environment may be provided to a viewer 102 on a television that provides the viewer 102 with a personal viewing experience. In certain embodiments, the viewer environment may create or store viewer or household profiles. In such cases, the advertisement controller 214 may also configure a TV application 112 to utilize the data in the viewer profiles that are generated by a personalized viewer environment in to customize the presentation of advertisements.

The server communication component 215 may permit a user 101 to configure a TV application 112 to communicate with an external server over the second network 170. The server communication component 215 may communicate with a server over the second network by utilizing a wired or wireless connection (e.g., a WiFi connection or Ethernet connection) that is provided by a television 110 or auxiliary content delivery device 140. The TV application 112 may communicate with a server to retrieve data or content from the server, utilize functions performed on the server, query databases on the server, utilize calculations performed on the server, or for other reasons. The TV application may be configured to communicate with the development server 120, distribution 180 or any other server. In certain embodiments, the functionality of the server communication component 215 may be integrated or utilized by the application modules 212 and/or application templates 211.

The server communication component 215 may permit a user 101 to incorporate functionality into the TV application 112 for retrieving updates. For example, the server communication component 215 may permit a TV application 112 to automatically download and install updates, to detect when updates are available, and/or present a viewer with an option for downloading or installing available updates. As explained above, in certain embodiments a configuration file may be generated that includes an identifier for a TV application that allows the television, or other device, to retrieve compiled application data from a remote storage location in response to the application being executed or installed by the device. In such embodiments, the server communication component 215 may also be configured to update the configuration file.

The server communication component 215 may be further configured to permit a user 101 to access and/or incorporate content (e.g., images and videos) from an external server into a TV application 112 being created and/or updated. The server communication component 215 may also be configured to permit a user to incorporate functions performed by an external server into a TV application 112 being created and/or updated. This may include functions related to calculations performed by the server, querying a database stored on the server, etc.

In certain embodiments, the server communication component 215 that may assist a user 101 in creating a TV application 112 that operates in the same or similar manner as a mash-up application. As known in the art, mash-up applications typically combine or blend content from other sources to create a new application. For example, a user 101 may design an TV application 112 for an image gallery that incorporates image data from Google images or a photography website. As another example, suppose a user was designing an application that provides directions to a specified location. In this example, the server communication component 215 may permit a TV application 112 to incorporate or utilize the functions performed by both MapQuest (e.g., to provide a user with directions for an automobile) and HopStop (e.g., to provide a user with directions for a bus, subway or train). Thus, when someone utilizing the TV application 112 requests directions to particular location, the TV application 112 may utilize the functions and/or content provided by MapQuest and HopStop for calculating the directions.

In order to incorporate the functionality or content provided by an external server, the server communication component 215 may provide one or more pre-made communication modules that are preconfigured to communicate with application programming interfaces (APIs) provided by external servers. For example, staying with the example discussed above, the server communication component 215 may include communication modules for interacting with APIs provided by MapQuest and HopStop. The APIs provided by these websites, or other websites, may permit a TV application 112 to seamlessly access, utilize and/or incorporate the functions and content provided by these websites. The server communication component 215 may include a communication module for nearly any external server. In certain cases, the server communication component 215 may also permit users 101 to upload new or custom communication modules as well.

The head-end communication component 216 may perform operations similar to those performed by the server communication component 215, except with respect to a TV head-end 130 accessible over the first network 160. The head-end communication component 216 may permit a user to configure a TV application 112 to communicate with a TV head-end 130 over the first network 160. The TV application 112 may be configured to communicate with the TV head-end 130 to retrieve, incorporate, or utilize data or content from the TV head-end 130 (e.g., program data 132) into a TV application. The TV application 112 may further be configured to incorporate or utilize functions performed by the TV head-end 130, query databases located at the TV head-end 130, retrieve or utilize viewer profiles from the TV head-end 130, or for other reasons. In certain embodiments, the functionality of the head-end communication component 216 may be integrated or utilized by the application modules 212 and/or application templates 211.

The head-end communication component 216 permits a user 101 to incorporate functionality into the TV application 112 for retrieving updates (e.g., updates to TV applications 112 or configuration files stored on a viewer's television) from the TV head-end 130. This may include automatically downloading or installing updates, detecting when updates are available, and/or presenting a viewer 102 with an option for downloading or installing available updates.

The head-end communication component 216 may be further configured to permit a user 101 to access, utilize and/or incorporate program data 132 or other data from a TV head-end 130 into a TV application 112. For example, the head-end communication component 216 may permit a user 101 to customize a TV application 112 using data from the TV head-end, such as listings of available on-demand movies, demographic information collected by the TV head-end 130, advertising information (e.g., actual advertisements or meta data describing the advertisements), or information from an electronic programming guide (EPG). The head-end communication component 216 may also be configured to permit a user 101 to utilize or incorporate functions performed by a TV head-end 130 into a TV application 112 being created and/or updated (e.g., providing a list of on-demand selections or permitting viewers to purchase content via a television).

Like the server communication component 215, the head-end communication component 216 may provide pre-made communication modules that are configured to communicate with an API provided by a TV head-end 130. The communication modules may permit the user to access or utilize the content and functions provided by the TV head-end 130.

The various tools 210 described in this disclosure are not meant to provide a comprehensive listing of all tools 210 that may be utilized by an application development platform 150. Rather, the tools described herein are merely meant to illustrate a few exemplary tools 210 that may be useful for developing TV applications 112 or other types of applications. Thus, it should be recognized that the application development platform 150 described herein may include additional tools 210 as well. For example, additional tools 210 may be provided for creating distributed applications (e.g., a TV application 112 includes a local portion stored on a television 110 and a second portion stored on either an external server or TV head-end 130), for handling billing information (e.g., for charging viewers a one time fee or recurring charge associated with an application or for purchasing items using an application), for integrating TV applications 112 with social networks (e.g., Facebook, Twitter, LinkedIn, etc.), or for integrating TV applications 112 with a viewer environment (described in further detail below). In fact, nearly any tool or module that can be utilized for creating and/or updating applications can be incorporated as a tool 210.

Moreover, it should also be recognized that many of the other components described in this disclosure may include functionality that overlaps or supplements the functionality provided by the tools 210. Thus, other components described in this disclosure may also be conceptualized as a tool 210 in some sense as well.

The application converter 240 may be configured to perform tasks related to converting or translating an application (or input provided by a user) into a particular format that is compatible with a target platform, device and/or operating system. The type of translations that may be performed by the application converter 240 and the manner in which the translations are performed may vary.

In certain embodiments, when a user 101 designs a TV application 112 using the application development platform 150, the TV application 112 may be initially created in a first format (e.g., in a generic format that stores all of the input and selections identified by the user). After creating the initial application in the first format, the user 101 may then select a particular application format for which the application is to be tailored or created. The application format selected by the user 101 may indicate a platform, device and/or operating system for which the application is to be translated. The application converter 240 may then translate the initial application having a first format into a new application having a second format that is compatible with the selected application format.

In certain embodiments, it may be preferable to generate the initial application in the first format using a domain-specific or markup language (e.g., HTML 5), rather than an true programming language (e.g., C or Java). These types of languages may be preferable since the application converter 240 will not have to perform more complex operations aimed at interpreting or understanding a process flow that is implemented by a true programming language (e.g., which may involve deciphering variables, for loops, if statements, include statements, etc.). In contrast, domain-specific or markup languages tend to be declarative in nature, and may primarily serve to indicate how data should be represented and/or rendered as opposed to how the data should be processed or manipulated.

In many cases, the elements (e.g., tags, attributes, events, objects, etc.) of a domain-specific or markup language can be recognized relatively easy in comparison to a true programming language. Consequently, each of the elements may be correlated to pre-made modules that are specific to a selected application format. Thus, when a user wishes to create an application for a particular application format, the application converter 240 may detect which elements are present in the initial program, and then retrieve corresponding modules that perform the same or similar functions for the selected application format. After all of the modules are retrieved, the application converter 240 may incorporate them into a program shell for the selected application format. This may include incorporating the modules as predefined methods (or sub-routines) which may be called by a main portion of a program, or incorporating the modules into the main portion of a program. The resulting application may then be compatible with a platform, device and/or operating system that has been selected by a user 101.

To illustrate this by way of example, suppose that an application development platform 150 initially constructs a TV application 112 in a markup language, such as HTML 5. Further suppose that the application development platform 150 includes an application converter 240 which includes a first conversion template for converting the initial application to be compatible with a specific device such as the Samsung 8000 Smart TV, and a second conversion template which converts the initial application to an application compatible with a specific platform such as NetTV (e.g., which may be utilized by multiple devices offered by different manufacturers).

For each conversion template, a library of pre-constructed application modules may be provided to incorporate specific features into an application. For example, for the first conversion template, a library of modules may be provided for the Samsung 8000 Smart TV which include application modules for incorporating a contact form, uploading a file, providing a shopping cart, etc. A similar library of application modules may also be provided for the NetTV platform that perform the same functions.

In order to translate the initial application which is written in HTML 5 into a new application for either the Samsung 8000 Smart TV or the NetTV platform, the application converter 240 may initially determine the set of features that were specified by the user 101 for the application 112. In the case that the initial program is written in HTML 5, this may include analyzing the initial program to detect the presence of certain tags (e.g., <html> tag, <body> tag, <form> tag, <table> tag, <a href> tag, other any other type of tag that is defined in the HTML 5 specification), events (e.g., onmouseover event, onclick event, ondblclick event, ondragover event, onscroll event, etc.), and/or content (e.g., text, images, videos, etc.). The analyzing operations may utilize regular expressions and/or string searching functions to detect the elements of the initial program, as well as attributes (e.g., size, width, height, alignment, etc.) of each element.

After the initial program has been analyzed and the features of the program have been detected, the application converter 240 may then select corresponding modules in the libraries associated with the Samsung 8000 Smart TV or NetTV platform based on the tags, events and/or content that was detected. For example, if a <form> tag was detected in the initial program, the application converter 240 may retrieve a corresponding module for displaying a form on the Samsung 8000 Smart TV or the NetTV platform. Furthermore, the attributes of the tags (or other elements) may be utilized to customize the selected module. For example, if the <img> tag was detected, the “src”, “width” and “height” attributes associated with this tag may be used to customize the module associated with the selected application format accordingly.

For each conversion template, the application converter 240 may also provide one or more corresponding “application shells”. The application shells may represent a very basic structure of a program that is compatible with the selected application format. For example, an application shell may include an empty outline for a program that sets up the main class for a program and initializes a basic set of variables that may be utilized by the application. After all of the corresponding modules are selected from a library associated with the selected application format, the modules may be incorporated into the program shell to generate a new application for the selected application format which includes the same or similar functionality as the initial application.

The application converter 240 may convert the inputs provided by a user 101 into an application in other ways as well. In certain embodiments, rather than creating an initial application in a specific language (e.g., HTML 5), the application converter 240 may record all of the selections in a generic settings file in a manner which is language independent. The settings file may be considered language independent in the sense that it not written in a written in a particular language (e.g., HTML 5) but merely includes a listing of the content, design elements and other application features (e.g., forms, links, tables, etc.) which are to be incorporated into a selected application format. In addition to including the content and features which are to be incorporated into a selected application format, the settings file may also include corresponding metadata that describes attributes of the content and/or features (e.g., metadata that indicates where the features and content should be located on an interface, and how the features and data should be rendered in terms of size, font, alignment, etc.).

The application converter 240 may then translate the information stored in the settings file into the an application that is compatible with the selected application similar to the manner described above. However, rather than analyzing an initial program to detect the content and elements which are present, the settings file already includes the information and corresponding metadata. Thus, the data in the settings file may be utilized by a conversion template to determine which modules should be retrieved from a library associated with a selected application format. The retrieved modules may then be customized using the metadata in the settings file and incorporated into a program shell associated with the selected application format.

To illustrate this concept, consider an example where a user 101 has created an application that includes two application modules 212: a module 212 for providing a homepage interface and a module 212 for providing contact form interface. For the homepage module 212, the user customized the text the that should be displayed (e.g., including font style and font size), and uploaded a company logo. For the contact module 212, the user customized a contact form that included fields for “name” and “comments”, and further specified an email address that indicates where the contents of the form should be sent after the form is filled out by a viewer 102. Thus, in this example, the settings file would include generic data that specifies all of the features of interfaces that were customized by the user, along with any associated metadata (e.g., font sizes, horizontal alignment, vertical alignment, selected fonts, etc.). The generic settings file may also specify any type of templates that are being utilized for the application that is being created, and how the content and features are to be incorporated into the template(s).

After the user 101 has finished providing input, the user 101 may select a particular platform, device and/or operating system for translating the settings file into a program. Modules may be retrieved from a library associated with the selected application format which correspond to the data in the settings file. When incorporating the modules into a program shell associated with the selected application format, the modules may be customized using the associated metadata in the settings file.

The exemplary creation and/or translation schemes discussed above are merely provided as examples and are not meant to be limiting. The application converter 240 may translate the inputs provided by a user 101 into an application in other ways as well. For example, rather than selecting an application format after a user has provided input for designing the application, a user 101 may specify the application format for which the application is intended to be created at the beginning of the process. In this case, the application converter 240 may translate the user's input directly into a program shell associated with a particular application format as the input is provided. In a similar manner as that described above, the modules may be selected from a library associated with the selected application format as the user is providing the input in order to translate the user's input into a specific application format.

In some cases, the application converter 240 may also generate a configuration file that is adapted for transmission to, and execution on, a target device (e.g., television 110 or auxiliary content delivery device 140) associated with a particular application format. Rather than transmitting an entire application to the target device for storage, the configuration file may be transmitted to the target device. The configuration file may include an identifier for the application that permits the target device to retrieve the data (e.g., content, modules, display settings, etc.) associated with the application. When the TV application 112 is executed or installed by a viewer 102, the identifier in the configuration file can be utilized to retrieve the data associated with the application. This arrangement may be particularly useful in cases where the target device has limited resources (e.g., limited memory).

Moving on, the application development platform 150 illustrated in FIG. 2 also includes an application distributor 250. The application distributor 250 may be configured to transmit TV applications 112 to content delivery devices, such as televisions 110 or the auxiliary content delivery devices 140 described above. The application distributor 250 may also be configured to perform a variety of functions related to listing an application in a digital distribution platform, such as the digital distribution platforms 190 illustrated in FIGS. 1A-1D.

The application distributor 250 may be configured to communicate with an digital distribution platform 190 for several reasons. For example, the application distributor 250 may be configured to submit a TV application 112 or other application for approval in a digital distribution platform 190. It is often the case that a provider of an digital distribution platform 190 may approve an application 112 before the application 112 is listed in the digital distribution platform 190. To this end, the application distributor 250 may be configured to automatically submit an application 112 for approval to the digital distribution platform in response to a user request to do so.

Other communications between the application distributor 250 and an digital distribution platform 190 may include communications which involve transmitting the application to the digital distribution platform 190, transmitting updates to an application listed by the digital distribution platform 190, and receiving notifications from the digital distribution platform 190 that pertain to the application 190. The application distributor 250 may also be configured to transmit data to an digital distribution platform 190 that indicates terms of selling and/or using an application. For example, this may including transmitting pricing information and/or information relating to software licenses associated with applications listed in the digital distribution platform 190.

### Exemplary Methods for Creating, Updating and Distributing TV Applications

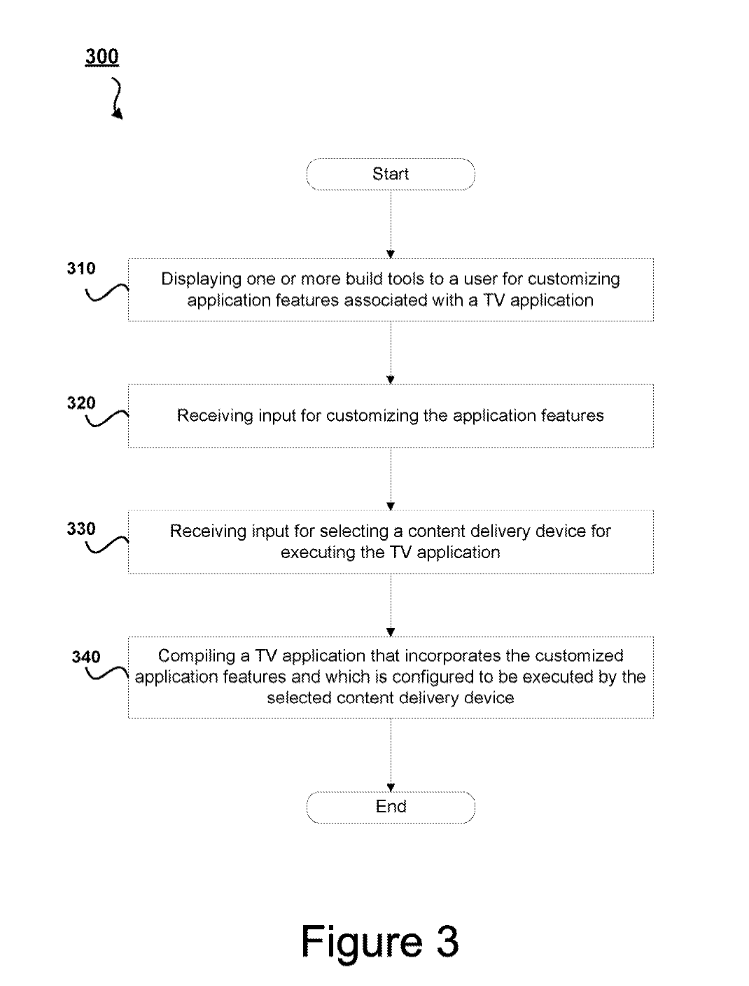

Moving on, FIGS. 3 and 4 demonstrate exemplary methods that may be utilized in conjunction with the principles described herein. Specifically, FIG. 3 discloses an exemplary method 300 for creating or updating a TV application in accordance with certain embodiments of the present invention. FIG. 4 discloses an exemplary method 400 for distributing a TV application to a user through a television device in accordance with certain embodiments of the present inventions.

The method 300 begins at the start block and proceeds to step 310, In step 310, one or more tools 210 are displayed to a user 101. The tools 210 may permit the user 101 to customize application features associated with a TV application 112. As illustrated in FIG. 2, exemplary tools 210 that may be utilized to customize application features may include application templates 211, an application modules 212, a security component 213, an advertisement controller 214, a sever communication component 215 and a head-end communication component 216. In addition, the design templates described above may also be utilized to customize the application features. Furthermore, it should be recognized that the tools 210 described in this disclosure may be supplemented with nearly any tool that assists a user in developing or updating an application. For example, additional tools 210 may be provided for creating distributed applications, for handling billing information, or for integrating TV applications 112 with social networks. These additional tools 210, or other tools, may also be utilized to modify the application features as well.

Input may be received from a user 101 to customize the application features associated with a television application that is being created or updated (step 320). For example, a user 101 may provide input via an input device 105. The input device 105 may be utilized to manipulate or interact with the tools 210 displayed on an interface of a television 110 or personal computing device 115.

The manner in which the tools 210 may be utilized to customize the application features may vary greatly. Customizing the application features may include customizing the content, application templates 211, and/or application modules 212 associated with a TV application. For example, the tools 210 may permit a user to adjust settings associated with the functional features that are displayed on the interfaces associated with the application modules 212 that are included in an TV application 112. The tools 210 may also permit a user to customize the appearance or design of interfaces associated with the application modules 212 (e.g., to customize the appearance and location of colors, logos, links, buttons and content) and to add or delete application modules 212 associated with a TV application 112 (e.g., to add o delete modules for contact forms, shopping carts, event calendars, etc.). Similarly, a security component 213 may permit a user to control access to a TV application 112, or content accessed by a TV application 112, and an advertisement controller 214 may permit a user to adjust the manner in which advertisements are displayed to viewers 102 via the TV application 112 (e.g., to determine the frequency at which advertisements should be shown, to determine which advertisements should be displayed to particular users, etc.)

Input may be also received be received from the user 101 that specifies a content delivery device on which the TV application 112 is to be executed on (step 330). In general, the content delivery device may represent any device that is capable of executing a TV application 112. Exemplary content delivery devices may include a television 110, set-top box, streaming device, or other auxiliary content delivery devices 140.

After a user 101 selects a content delivery device, a TV application 112 may be complied which incorporates the customized application features and which is configured to be executed by the selected content delivery device (step 340). For example, the user 101 may select a particular device (e.g., a particular television brand or model, or a particular brand or model for an auxiliary content delivery device 140) that the user would like the TV application 112 to be compatible with, and the customized application features identified by the user in step 320 may be incorporated into a TV application having a particular format that is compatible for execution on the device. Each content delivery device may include a particular platform and/or operating system that is utilized by the device. Thus, compiling a TV application 112 for execution on a target content delivery device may involve generating the TV application 112 in a format that is compatible with a particular platform and/or operating being utilized by the target content delivery device. In certain embodiments, the application converter 240 described above may be utilized to output the TV application 112.

In certain embodiments, the application features specified by the user may be incorporated into an application in a first format (e.g., into an HTML 5 application). In this case, compiling the TV application based on the selected content delivery device may include converting the application in a first format into a TV application 112 that is compatible with the selected content delivery device. In other embodiments, the customization preferences may be specified in a language independent file. In this case, compiling the TV application 112 may include transforming the user preferences stored in a generic settings file into a TV application that is compatible with the selected content delivery device. Other types of translation schemes may also be utilized.

After the TV application 112 is compiled, the method 300 proceeds to the end block and terminates. It should be noted that the method in FIG. 3 may be varied in different embodiments without departing from the scope of the principles described herein. For example, in certain embodiments, a user may select a target content delivery device at or near the beginning of the method and the tools 210 provided to the user may be configured to create a TV application in a format (e.g., programming language) that is specific to the selected content delivery device. Other types of variations are also contemplated.

FIG. 4 discloses an exemplary method 400 for providing a TV application 112 to content delivery device in accordance with certain embodiments of the present inventions. The method 400 begins at the start block at proceeds to step 410. In step 410, a TV application 112 is created using an application development platform 150. In certain embodiments, the TV application 112 may be created in the same or similar manner as discussed above with respect to FIG. 3.

After the TV application 112 is created, the TV application 112 may be transmitted from the application development platform 150 to one or more digital distribution platforms 190 in response to a user request (step 420). The digital distribution platforms 190 may be made available to a television 110 by a TV head-end 130 via first network (e.g., a cable or satellite television network) or by a distribution server 190 via a second network (e.g., Internet). As explained above, the digital distribution platforms 190 may provide a service that permits users 101 to upload and/or sell TV applications 112 to viewers 102. The viewers 102 may download and/or buy TV applications 112 from the digital distribution platform 190.

In certain embodiments, a user 101 who has created a TV application 112 (e.g., using the application development platform 150) may select one or more digital distribution platforms 190 where the user 101 wishes to list TV application 112 for downloading and/or purchasing by viewers. The development platform 150 that assisted the user in creating the TV application may automatically forward the user's TV application 112 to the digital distribution platform 190 in response to receiving a request from the user 101. The TV application 112 may initially be submitted to the one or more digital distribution platforms 190 for approval. In certain embodiments, this step may be performed by the application distributor 250 described above. In other embodiments, a user 101 that created or updated the TV application 112 may manually submit the TV application 112 to an digital distribution platform 190.

The TV application 112 may be listed in the one or more digital distribution platforms 190 to enable the TV application 112 to be downloaded by one or more content delivery devices (step 430). Exemplary content delivery devices may include a television 110, set-top box, streaming device or other type of auxiliary content delivery device 140. Viewers 102 may view a listing of TV applications 112 provided by the digital distribution platform 190 via a display 114 on the television. For example, a viewer's 101 television 110 or other content delivery device may include an pre-installed application that provides access to the listing of TV applications provided by the digital distribution platform 190.

Once the TV application is listed in the one or more digital distribution platforms 190, the TV application 112 may be downloaded and installed on a television 110 or other content delivery device of the viewer 102 in response to the viewer 102 selecting and/or purchasing the TV application (step 440). The method 400 then proceeds to the end block and terminates.

### Personalized Viewer Environment

Moving on, the application development platform 150 described above may also permit a user 101 to integrate a TV application 112 with a viewer environment that is displayed to a viewer 102. The disclosure provided below provides further details regarding a novel viewer environment that may be provided to viewers 102.

Conventionally, a television 110 was utilized primarily by viewers 102 to watch television programs. However, by integrating a viewer's television with the viewer environment 550 described herein, the scope of a viewer's interaction with a television 110 is greatly expanded. The viewer environment 550 may include a variety of interfaces and functions that provide a viewer 102 with unique type of TV viewing experience. Rather than simply turning on a television 110 to watch a movie or television program, a viewer 102 may turn on the television to access personalized viewer environment 550.

To briefly illustrate the concept of a viewer environment 550, consider an exemplary viewer environment 550 that includes a homepage interface or wake-up page interface that is personalized to the viewer 102. The personalized homepage may provide elements that permit a viewer 102 to access email accounts and to view social networking data (e.g., view updates on Facebook, Twitter, LinkdIn or Instagram). The homepage may further provide the viewer 102 with access to a set of TV applications 112 that have been downloaded or installed by the viewer 102, a contact list that includes contact information for other viewers 102 and persons, and a set of communication tools. The communication tools may permit the viewer 102 to communicate with other viewers 102 over the first network 160 or other persons that are connected to the second network 170 using a personal computing device 115. The viewer 102 may further customize the homepage with various types of widgets or applications (e.g., widgets for displaying the weather in the viewer's location or widgets for displaying data related to RSS feeds).

All of the preferences and personalization settings associated with the viewer environment 550 may be stored in a profile for a viewer 102 or viewer household. The profile may be stored at a TV head-end 130 and/or server. The viewer 102 may access the profile by logging into an account (e.g., by providing a username and password) from a television 110 that is connected to the first network 160 or second network 170. In this manner, a user may access the personalized viewer environment 550 from any television, including televisions 110 located remotely from the viewer's home.

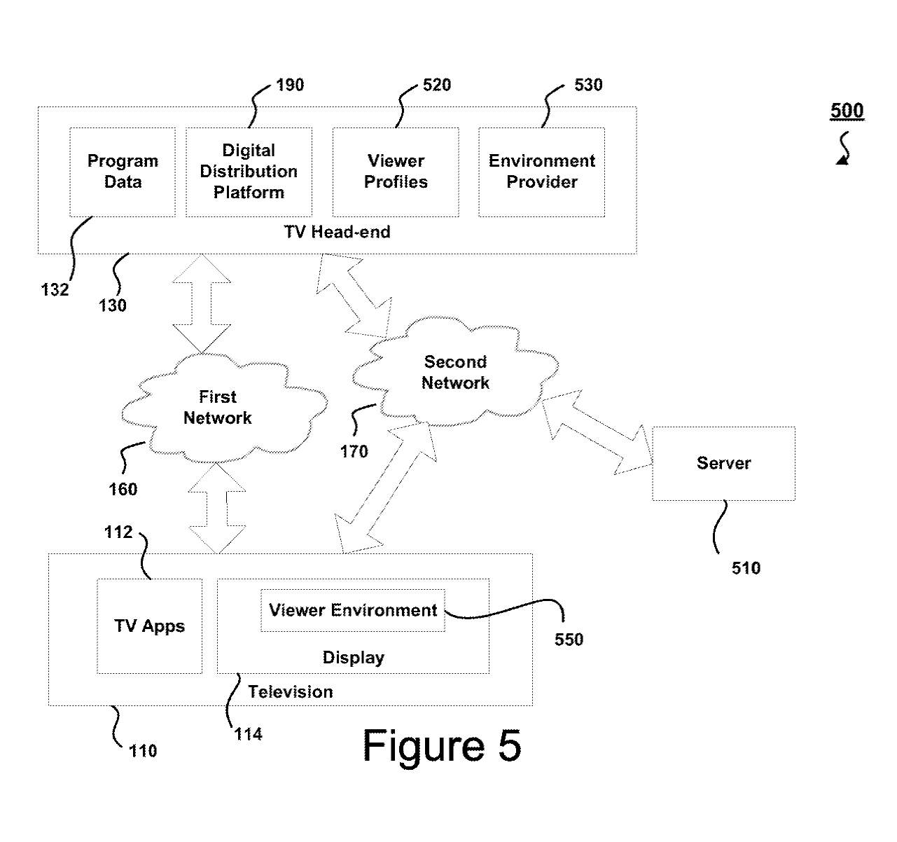

FIG. 5 illustrates an exemplary system 500 for providing a viewer environment 550 to a viewer 102 in accordance with certain embodiments of the principles described herein. In this exemplary embodiment, a TV head-end 130 includes an environment provider 530. The environment provider 530 may be configured to transmit data to a television 110 in order to display a viewer environment 550 on the display 114 of a television 110. A viewer profile 520 may created for each viewer or viewer household. The environment provider 530 may utilize data stored in a viewer profile 520 in order to provide a viewer environment 550 that is personalized to the viewer 102 or viewer household. A viewer 102 may interact with the viewer environment 550 utilizing an input device 105 (e.g., a remote control).

The exemplary configuration of the system 500 in FIG. 5 may be altered in various ways. For example, in certain embodiments, the environment provider 530 and/or viewer profiles 520 may be located one on a server 510 that is connected to the second network 170. Further details regarding alternative embodiments are discussed in greater detail below.

The viewer environment 550 may be personalized in many different respects. For example, the personalization features may extend to interfaces that can be customized to the viewer 102 (e.g., an interface may display a viewer's appointments for the day, contact list, email notifications, bill pay reminders, etc.) The personalization features may also extend to displaying notifications and other data from the social networking sites that the viewer 102 has selected, and selectively displaying advertisements based on viewer's preferences or characteristics. Content that is recommended or presented to the user (e.g., program data 132, website content, etc.) may also be personalized.

As briefly mentioned above, a viewer profile 520 associated with a particular a viewer or viewer household may include personalization data that indicates all of a viewer's personalization settings and related data. Generally speaking, the personalization data in the viewer profile 520 may include any data that relates to a viewer (or household) or the viewer's interaction with the viewer environment. In some cases, the environment provider 520 may provide a function that permits a viewer 102 to create a viewer profile 520. The personalization data or information in a viewer profile 520 may be explicitly provided by a viewer (e.g., by filling out a form or selecting options using a remote control) or may provided by tracking or monitoring operations performed by the viewer environment 550.

For example, the viewer profile 520 may indicate personal information about the user (e.g., name, address, age, sex, height, weight, etc.), the viewer's interests or hobbies (e.g., sports, hunting, fishing, exercising, cooking, knitting, etc.), and the viewer's television viewing habits (e.g., preferred channels, preferred programs, programs downloaded by a user, how often a user watches television, etc.). The viewer profile 520 may further indicate the viewer's online viewing habits (e.g., websites frequently accessed by the viewer via the television, content download from the Internet to the television, genres of websites frequently accessed by a viewer, etc.), social network data (e.g., social networks that the viewer has joined or visited, usernames and passwords for social networks, the viewer's friends or connections on a social network, data stored on a user's profile on a social network, etc.), and a list of contacts (e.g., contact information from a contact list provided by a viewer's mobile device, email account and/or social network, information that specifies an address on a television network associated with another viewer's terminal or television 110, etc.).

The viewer profile 520, which may be may associated with a character (e.g., an avatar) and various types of data describing the viewer 102, can be utilized by the viewer environment 550 in various ways. In certain embodiments, the viewer profile 520 may be utilized to track various types of activities associated with a viewer or household, to personalize features of the viewer environment 550 and to facilitate communications with others through the television 100. In addition, the viewer profile 520 may be stored at a centralized location (e.g., a TV head-end 130 or server 510), thus permitting the viewer environment to accessed remotely by a viewer 102 from a remote location located outside of the viewer's home. The manner is which the viewer profile 520 assists in performing these functions is described in further detailed below.

Any TV application 112 can be integrated with the viewer environment 550 including TV applications 112 that are created by the application development platform 150 described above. In fact, the application development platform 150 may provide a tool 210 for integrating an application 112 with the viewer environment 550.

Applications 112 may be integrated with the viewer environment 550 in the sense that the data, content or functions associated with these applications may be utilized by the viewer environment 550, and the data associated with these applications may be utilized to update the viewer profiles 520 (or may be made accessible to the viewer environment 550 in some manner). Thus, in addition to the data described above, the viewer profile 520 may also include information that is associated with TV applications 112 that have been integrated with the viewer environment 550. For example, the viewer profile 520 may include information that indicates how often a viewer accesses an application, the extent that the application 112 is used by a viewer, how far a user has progressed in an application (e.g., the level reached in a gaming application and the viewer's total score), or any other type of information that is associated with the application 112.

Although information associated with a viewer profile 520 may be described in this disclosure as being stored in a file associated with the viewer profile 520, such is not required. Rather, the viewer profile 520 may simply provide information or associations that permit retrieval of such information. For example, in certain embodiments, the viewer profile 520 may not store information relating to a viewer's social networking connections. However, the viewer profile 520 may include the viewer's username and password to the social network in order to retrieve information pertaining to the viewer's connections over a network.

Any portion of the data or information in a viewer profile 520 may be utilized to personalize the viewing experience and/or interaction with the television 110. The discussion immediately following demonstrates several examples of the data in a viewer profile 520 may be utilized to provide a personalized viewer environment 550. Specifically, the discussion below addresses how the data in a viewer profile 520 may be utilized to personalize a homepage interface (or wake-up page interface), an RSS feed, advertisements, and configurations for a set of communication tools.

As mentioned above, the viewer environment 550 may also include a homepage interface (or other similar interface) that can be personalized with information from the viewer profile 520. The personalized homepage utilize data in a viewer profile 520 to permit a viewer 102 to access email accounts. The personalized homepage may also utilize information in the viewer profile 520 in order to display notifications from social networking sites and to permit viewers 102 to post data (e.g., text, images, videos, etc) to social networking sites.

Viewers 102 may further customize the homepage interface by selecting applications or widgets that are to be displayed on the homepage interface. Exemplary widgets may include widgets for displaying the weather in the viewer's location, birthday reminders, and a “to-do” list. Other types of widgets may also be incorporated into the homepage interface.

In certain embodiments, a viewer 102 may also incorporate a widget for displaying an RSS feed that can be customized by the viewer 102 and which updates in real-time. The RSS feed may display data relating to the viewer's interests (e.g., articles published on websites and/or programs broadcast over a television network that are of interest to the viewer 102) and data or content from social networks that the viewer 102 has joined (e.g., content posted by the viewer's connections, content posted on the viewer's profile, etc.).

In certain embodiments, the RSS feed may be provided as an overlay element that sits or floats on top of program data 132 being watched by a user or other data being displayed on the television 110. In other embodiments, the RSS feed may be provided on an entirely separate interface (e.g., which may be accessed by selecting an option on a menu). In even further embodiments, the RSS feed may be implemented as a news ticker or news scroller that is displayed across the bottom on a television display 114.

In addition to displaying data associated with widgets that are selected by a viewer 102, the homepage may further provide the viewer 102 with access to a set of TV applications 112 that have been downloaded or installed by the viewer 102, a contact list that includes contact information for other viewers 102 and persons, and a set of communication tools.

The communications tools may permit the viewer 102 to communicate with other viewers 102 over the first network 160 or other persons that are connected to the second network 170 using a personal computing device 115. For example, a viewer 102 may be permitted to communicate with other viewers 102 via the first network 160. Utilizing cameras and/or microphones (or other input devices), viewers 102 may see each other on the display 114 and speak to one another. Viewers 102 may also communicate by sending messages through a television 110. For example, two viewers 102 watching the same show may exchange messages similar to a manner in which an instant messaging application operates. A viewer 102 may also send a message to an inbox for a viewer's account that is associated with the viewer environment 550. The communication tools may further permit a viewer to send suggestions to other viewers 102 (e.g., suggesting that a viewer watches a particular movie or television show that is airing).

The communications tools may also permit the viewer 102 to communicate with other viewers 102 over the second network 170. For example, the communication tools may permit viewers 102 to post data (e.g., text, images, video, etc.) to social networking sites and may include APIs to directly communicate with other persons via social networking sites. In certain embodiments, the communication tools may further permit a viewer 102 to communicate directly with a personal computing device 115 that is connected to the second network 170.

In order to facilitate communication with others over the first network 160 or second network 170, the viewer profile 520 may store a contact list for a viewer 102. In certain cases, the contact list may be accessible to a viewer via an element that is display on the homepage interface. The contact list may include various types of contact information for contacting others. For example, the contact list may include a television network address of other viewers 102 (e.g., which indicates the location of a viewer's television 110 or set-top box on the first network 160), email addresses, phone numbers, IP addresses, and other types of contact information.

A viewer 102 may select a contact in the contact list and select a means of communicating with the contact. For example, a viewer 102 may access the television network address of another viewer in order to send a message directly to the television of the viewer 102 or to setup a live video conferencing session with the other viewer 102. Likewise, a viewer 102 may access email addresses for a contact in the contact list in order to send an email to the contact.

For facilitating particular types of communications between two viewers 102, the communication tools may transmit input (e.g., video streams, audio streams, textual messages, images, etc.) from a viewer 102 at a first location via a first network 160 to a TV head-end 130 which relays the input to another viewer 102 at a second location. In other embodiments (e.g., in which the environment provider 530 and viewer profiles 520 are located on a server 510), the input provided by a viewer 102 at a first location may be transmitted over a second network 170 to a server 510 which relays the input to the television 110 of a viewer 102 at a second location (e.g., using WiFi connections for both viewers). Thus, the contact list information stored in a viewer profile 520 may be utilized to establish a communication pathway between the televisions 110 of two more viewers, thus permitting them to communicate via their televisions 110.

The viewers may communicate manner in which viewers communicate can vary. For example, if a video camera and/or microphone is connected to the viewers' televisions 110 (or otherwise in communication with the viewers' televisions 110), the viewers may communicate with each other via video streams (e.g., the viewers may permitted to see one another in picture-in-picture element on their displays 114) and/or audio steams (e.g., the viewers' voices are output through speakers or through a connected headset). As explained above, the viewers may also communicate through an instant messaging application or similar type of application.

In certain embodiments, the communication pathway establish among the televisions 110 of two or more viewers 102 may also permit viewers 102 to jointly utilize applications. For example, users may jointly play TV gaming applications 112 together over either the first network 160 or second network 170, or may collaborate on a project (e.g., a computer-assisted design project) using distributed applications.

Communications among viewers may also extend to sharing content or suggesting content to each other. For example, a viewer 102 may send a recommendation to a friend if the viewer believes that the friend may be interested in a certain piece of content (e.g., an image or video stored on the viewer's television or located on a social network), or a certain feature (e.g., certain feature or function associated with the viewer environment 550). Recommendations may also be sent for programs (e.g., a live televisions programs or an on-demand programs), TV applications 112, websites, or other data.

Notifications may appear on the television of a viewer 102 that has been sent a recommendation to notify the viewer 102 of the recommendation. The notifications may provide links to the data or functions associated with the recommendation. For example, if a viewer 102 received a recommendation to watch a particular program, a notification may appear on the viewer's screen. The viewer may select the notification to view the recommended program, or may select relevant functions (e.g., functions to record the show or display the show in a picture-in-picture element on the display 114).

As mentioned briefly above, the personalization features provided by the viewer environment 550 may also extend to the personalization of advertisements. Advertisements may be displayed to viewers 102 in various ways (e.g., via the TV applications 112, via program data 132, or through the actual viewer environment itself). Any of the advertisements displayed to viewers can be personalized based on the information in a viewer profile 520. In certain embodiments, the viewer environment 550 may correlate the information in a viewer profile 520 with certain categories of advertisements in order to determine which advertisements may be displayed to a viewer. For example, if the viewer profile 520 includes information on viewing habits that indicates that a user frequently watches football, then the viewer environment 550 may determine that advertisements dealing with sports apparel or tickets may be displayed to the viewer 102. In certain embodiments, the viewer environment 550 may utilize any of the schemes for displaying advertisements that were discussed above with respect to the advertisement controller 214.

It should be evident from the discussion provided above that the viewer profile 520 provides a basis for personalizing nearly any feature of the viewer environment 550. While the examples provided above demonstrate some exemplary personalization schemes, it should be recognized that a viewer profile 520 may be utilized to personalize a viewer environment 550 in other ways as well.

Another advantageous aspect of the viewer environment 550 relates to the fact that the viewer environment 550 is portable. The viewer environment 550 is portable in the sense that viewers 102 can access the viewer environment 550 from other televisions 110 (e.g., televisions 110 located outside the viewer's home). For example, suppose a viewer 102 had to travel across the country for a business trip. The viewer 102 may be permitted to login (e.g., by providing login credentials) and access the viewer environment 550 that the viewer enjoys at home, along with all of the viewer's personalization settings, contact lists, etc.

In certain embodiments, the viewer 102 may access a viewer environment 550 from a remote location by logging in (e.g., with a username and password) to an authentication module provided by a centralized location in order to retrieve a viewer profile 520 associated with the viewer 102. The manner in which this is performed may vary based on the configuration of the system.

In the exemplary embodiment illustrated in FIG. 5, the environment provider 530 and viewer profiles are located at the TV head-end 130. Thus, an authentication module (e.g., an input form for entering the username and password) may be provided to any television 110 in communication with the TV-head end 130 via the first network 160. Upon entering valid login credentials, a viewer 102 may access his or her viewer profile 520 and the environment provider 530 may render a viewer environment 530 on the television 110 of the viewer 102.

For example, suppose a viewer who lives in New York goes on a business trip to California. If the hotel the viewer is staying at in California has a television 110 connected to the first network 160, the viewer may access the viewer profile 520 and the associated personalization settings. By retrieving this information, the television 110 at the hotel may display the same personalized viewer environment 550 (e.g., which may include a personalized homepage, RSS feed, contact list, bill pay reminders, etc) that the viewer 102 accesses at home.

In other embodiments, it may be preferable to locate the authentication module, along with the viewer profiles 520 and viewer environment 550, on an alternative centralized location such as a server 510 that is accessible over the Internet. This may be advantageous because it may be permit a viewer to login and access the personalized viewer environment 550 from any television that included a connection (e.g., Wi-Fi connection or Ethernet connection) to the second network 170. This configuration may enable a viewer to access the personalized viewer environment 550 regardless of whether the television 110 is connected to a particular television network or TV head-end 130 (e.g., regardless of whether the remote television 110 that the viewer is attempting to login from is connected to the same television provider as the viewer's home television).

In even further embodiments, the environment provider 530 may be located at a viewer's residence. For example, the environment provider 530 may represent an application that is pre-installed on a television 110 or downloaded to a television 110. In other embodiments, the viewer environment 550 may represent a feature or component that is provided as part of an operating system or platform for a television 110. In even further embodiments, the environment provider 530 may be provided by an auxiliary content delivery device 140 (e.g., set-top box or streaming device) attached to a television 110. In cases where the environment provider 530 may be located at a viewer's residence, the viewer profiles 520 may be periodically transmitted to a server 510 (or TV head-end 130) in order to permit a viewer 102 to login and access to the viewer profiles 520 from other televisions 110.

Similarly, the location of the viewer profiles 520 may also varied. In the exemplary system 500 shown, the viewer profiles 520 are stored at the TV head-end 130 connected to the television 110 via a first network 160. However, in other embodiments, the viewer profiles 520 may be stored at a server 510 or locally on the televisions 110 (or auxiliary content delivery devices 140) of viewers. In cases where the environment provider 530 may be located on a television 110 (or set-top box or auxiliary content delivery device 140), the viewer profiles 520 may be periodically transmitted to a server 510 (or TV head-end 130) in order to permit a viewer 102 to login and access to the viewer profiles 520 from other televisions 110.

It should be noted that any of the system alterations discussed above with respect to FIGS. 1A-1D may also be utilized to modify the system 500 in FIG. 5. For example, the television 110 illustrated in FIG. 5 may represent a television, a set-top box, or any combination of the two in the same or similar manner as described above with respect to FIGS. 1A-1D. Furthermore, an auxiliary content delivery device 140 may be employed to connect to the first network 160 or second network 170. Numerous additional variations are also contemplated.

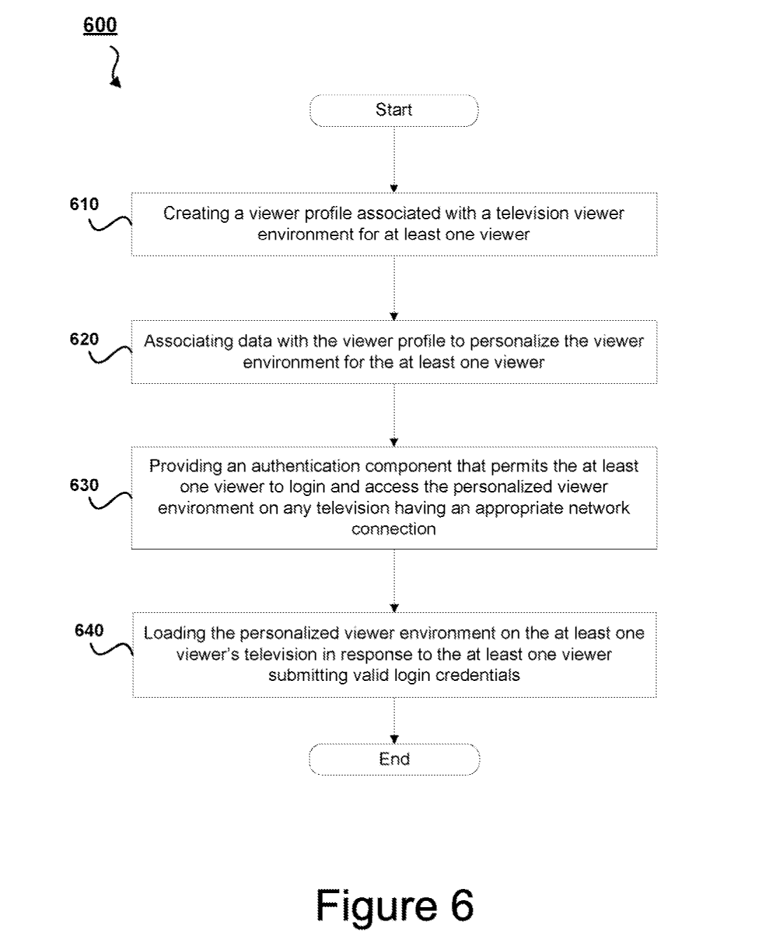

FIG. 6 illustrates an exemplary method 600 for accessing a viewer environment 550 on a television in accordance with certain embodiments of the present principles. The method 600 begins at the start block and proceeds to step 610. In step 610, a viewer profile 520 associated with a television viewer environment 550 is created. The profile 520 may be created for at least one viewer (or household).

In step 620, data is associated with the viewer profile 520 in order to personalize the viewer environment 550 for the at least one viewer. As explained above, the data may include any type of data that pertains to a viewer. For example, it may include data relating to personal information, viewing habits, web surfing habits, purchasing habits, interests, social network data, contact lists, login credentials, etc. The data may further include settings for a homepage interface or data associated with TV applications 112 that have been downloaded and/or installed by a viewer 102.

The manner in which data is associated with the viewer profile 520 may vary. In certain embodiments, the data may be stored directly in a profile (e.g., in one or more files or databases that include the profile settings). In other cases, the viewer profile 520 may include a reference to the data that permits the viewer environment 550 to access and utilize the data. For example, suppose a viewer is a member of a social network, such as Facebook. The viewer environment 550 may include a contact list feature that populates the contact list with contact information about the viewer's Facebook connections. However, the viewer profile 520 may not actually store the contact information for the viewer's connections. Rather, the viewer profile 520 simply include a reference that identifies the viewer's Facebook account and provides login credentials in order to access the viewer's account and retrieve the contact information.

To demonstrate the various ways in which data may be associated with a viewer profile 520, consider an example in which a viewer creates a viewer profile 520 (e.g., possibly when the viewer purchases a new television or enters into a contract with a new television service provider). Initially, the viewer may provide some personal information including a name, address and phone number and may create login credentials (e.g., username and/or password). In certain embodiments, the viewer may also create an avatar or character associated with the viewer profile 520. All of this information may be associated with the viewer profile 520.

After the viewer has gone through the initial set-up process for creating a viewer profile 520, additional data may be associated with the viewer profile 520 as the viewer customizes features of the viewer environment 550. For example, additional data may be added to the viewer profile 550 as the viewer customizes the homepage interface or RSS feed provided as part of the viewer environment 550.

Data may also be associated with the viewer profile 520 in response to the viewer downloading or installing new TV applications 112. For example, the viewer profile 520 may include data that indicates all of the TV applications 112 that have been downloaded and/or purchased by a viewer 112. Additional data be provided for TV applications 112 that are integrated with the viewer environment 550. As explained above, a integrated TV application 112 may provide the viewer environment 550 with access to the underlying data associated with the TV application 112, or with access to certain functions performed by the TV application 112. Thus, the viewer profile 520 may be associated with the TV application's 112 underlying data and may include references to utilize functions performed by the TV application 112.

Additional data may automatically be associated with a viewer profile 520 based on certain activities. For example, data may be associated with the viewer profile 520 that indicates a viewer's television viewing habits, web browsing habits, purchases, or other type of data.

The manner in which the viewer profile 520 may be utilized to personalize a viewer environment 550 can vary greatly. In certain embodiments, personalizing a viewer environment 550 may include one or more of customizing an RSS feed, customizing a wake-up screen display, customizing advertisements displayed to a viewer, customizing recommendations presented to a viewer (e.g., recommendations to download TV applications 112 or watch certain programs), customizing a list of contacts that a viewer may communicate with via the television 112, customizing the appearance of interfaces associated with a viewer environment (e.g., color schemes, fonts or background images), and customizing a set of applications available to the viewer. The viewer environment can be personalized in numerous other ways as well.

Thus, the data in the viewer profile 520 may be utilized to define a viewer environment 550 for a viewer (or household of viewers). A viewer's television 110 at home may automatically display the personalized viewer environment 550 when a viewer turns on the television 110 (e.g., using the login credentials the viewer initially created a new viewer profile 520) unless the viewer logs out his account or profile. However, in the case that a viewer logged out of the viewer profile on the television 110 in the viewer's home, or in the case that a viewer wished to access the personalized viewer environment 550 from outside the home, the viewer may be required to provide login credentials to access the viewer profile 520 and personalized viewer environment 550.

Thus, an authentication component may be provided to permit the viewer to login and access the personalized viewer environment from any television that has an appropriate network connection (step 630). The authentication component may provide a form or element on an interface that permits a user to submit a username and/or password. The authentication component may be transmitted for display on a television 110 by a TV head-end 130 or by server 510. A viewer 102 may submit login credentials using any type of input device 105.

To determine whether the login credentials are valid, the login credentials may be transmitted over a network (e.g., the first network or the second network) to a TV head-end 130 or server 510. The TV head-end 130 or server 510 may compare the login credentials to data in the viewer profile (e.g., to a username and password specified by the viewer 102 when creating the viewer profile) in order to determine whether the submitted credentials are valid.

In certain embodiments, an appropriate network connection may include a connection to a television network and/or a connection to the Internet. Other networks connections may be utilized. The type of appropriate connection may vary depending upon the configuration of the system. In some embodiments, the viewer environment 550 may be provided by an environment provider 530 located at a TV-head end 130. In other embodiments, the viewer environment 550 may be provided by an environment provider 530 on a server 510. In further embodiments, the environment provider 530 may be provided on a television 110 or connected auxiliary content delivery device 140 which transmits the viewer profiles to a server 150 or TV head-end 130. In even further embodiments, the components of the environment provider 530 may be distributed between a television 110 and a TV head-end 130 and/or server 150. Thus, the appropriate network connection may vary depending upon the particular configuration.

In response to a viewer submitting valid login credentials, the personalized viewer environment 550 may be loaded on the viewer's television 110 (step 640). Regardless of where the viewer is located, the viewer may access a personalized viewer environment 550 on a television 110 that is tailored to the particular viewer.

While there have shown and described and pointed out various novel features of the invention as applied to particular embodiments thereof, it will be understood that various omissions and substitutions and changes in the form and details of the systems and methods described and illustrated, may be made by those skilled in the art without departing from the spirit of the invention. Amongst other things, the steps shown in the methods may be carried out in a different orders in many cases where such is appropriate. Moreover, those skilled in the art will recognize, based on the above disclosure and an understanding therefrom of the teachings of the invention, that the particular hardware and devices that are part of the system described herein, and the general functionality provided by and incorporated therein, may vary in different embodiments of the invention. Accordingly, the particular system components shown in the figures are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation, and the present invention is limited only by the claims which follow.

What is claimed is:

1. A system for providing a viewer environment on a television device, comprising:
a processor configured to:
provide an authentication component that permits a viewer to access a profile on a television device having a network connection, wherein the profile includes personalization data for customizing a viewer environment and the personalization data is derived, at least in part, from the viewer's interaction with the viewer environment;
receive login credentials submitted by the viewer at a centralized location that is in communication with a plurality of television devices over a network and which is configured to transmit data associated with the viewer environment to the plurality of television devices;
determine whether the login credentials received from the viewer via the authentication component are valid;
grant access to the profile in response to determining that the login credentials received from the viewer are valid;
determine one or more customization aspects to be incorporated into the viewer environment based on the personalization data in the profile; and
provide data for rendering the viewer environment on the television device of the viewer, the viewer environment including the customization aspects associated with the personalization data.

2. The system of claim 1, wherein the centralized location is a television head-end that is configured to provide the viewer environment to the television device of the viewer over a television network.

3. The system of claim 1, wherein the centralized location is a server that is configured to provide the viewer environment to the television device of the viewer over the Internet.

4. The system of claim 1, wherein the personalization data includes at least one of the following:
data associated with television viewing habits of the viewer;
data associated with web browsing habits of the viewer;
data incorporated in a contact list for the viewer;
data derived from customizing an interface associated with the viewer environment; or
data derived from television applications downloaded by the viewer.

5. The system of claim 1, wherein the viewer environment comprises a homepage interface including one or more widgets that have been selected by the viewer.

6. The system of claim 1, wherein the viewer environment includes a communication tool that permits the viewer to communicate with a second viewer over a television network.

7. The system of claim 6, wherein communicating with a second viewer over the television network includes at least one of the following:
transmitting a message to the second viewer;
jointly utilizing a television application with the second viewer; or
sending a recommendation to the second viewer.

8. The system of claim 1, wherein the viewer environment includes a communication tool that permits the viewer to communicate with another individual over the Internet.

9. The system of claim 1, wherein the viewer environment is provided, at least in part, by a pre-installed or local function of the television device and the profile for the viewer is periodically transmitted to the centralized location over the network to permit the viewer to access the profile from a remote location.

10. The system of claim 1, wherein the viewer environment is provided, at least in part, by an auxiliary content delivery device that is located external to the television and in communication with the television.

11. A method for providing a viewer environment on a television device, comprising:
providing an authentication component that permits a viewer to access a profile on a television device having a network connection, wherein the profile includes personalization data for customizing a viewer environment and the personalization data is derived, at least in part, from the viewer's interaction with the viewer environment;
receiving login credentials submitted by the viewer at a centralized location that is in communication with a plurality of television devices over a network and which is configured to transmit data associated with the viewer environment to the plurality of television devices;
determining whether the login credentials received from the viewer via the authentication component are valid;
granting access to the profile in response to determining that the login credentials received from the viewer are valid;
determining, with a processor, one or more customization aspects to be incorporated into the viewer environment based on the personalization data in the profile; and
providing, with a processor, data for rendering the viewer environment on the television device of the viewer, the viewer environment including the customization aspects associated with the personalization data.

12. The method of claim 11, wherein the centralized location is a television head-end that is configured to provide the viewer environment to the television device of the viewer over a television network.

13. The method of claim 11, wherein the centralized location is a server that is configured to provide the viewer environment to the television device of the viewer over the Internet.

14. The method of claim 11, wherein the personalization data includes at least one of the following:
data associated with television viewing habits of the viewer;
data associated with web browsing habits of the viewer;
data incorporated in a contact list for the viewer;
data derived from customizing an interface associated with the viewer environment; or
data derived from television applications downloaded by the viewer.

15. The method of claim 11, wherein the viewer environment comprises a homepage interface including one or more widgets that have been selected by the viewer.

16. The method of claim 11, wherein the viewer environment includes a communication tool that permits the viewer to communicate with a second viewer over a television network.

17. The method of claim 16, wherein communicating with a second viewer over the television network includes at least one of the following:
transmitting a message to the second viewer;
jointly utilizing a television application with the second viewer; or
sending a recommendation to the second viewer.

18. The method of claim 11, wherein the viewer environment includes a communication tool that permits the viewer to communicate with another individual over the Internet.

19. The method of claim 11, wherein the viewer environment is provided, at least in part, by a pre-installed or local function of the television device and the profile for the viewer is periodically transmitted to the centralized location over the network to permit the viewer to access the profile from a remote location.

20. The method of claim 11, wherein the viewer environment is provided, at least in part, by an auxiliary content delivery device that is located external to the television and in communication with the television.

21. A non-transitory computer storage medium comprising program instructions for providing a viewer environment on a television device, wherein the program instructions, when executed on a computer, cause the computer to:
provide an authentication component that permits a viewer to access a profile on a television device having a network connection, wherein the profile includes personalization data for customizing a viewer environment and the personalization data is derived, at least in part, from the viewer's interaction with the viewer environment;
receive login credentials submitted by the viewer at a centralized location that is in communication with a plurality of television devices over a network and which is configured to transmit data associated with the viewer environment to the plurality of television devices;
determine whether the login credentials received from the viewer via the authentication component are valid;
grant access to the profile in response to determining that the login credentials received from the viewer are valid;
determine one or more customization aspects to be incorporated into the viewer environment based on the personalization data in the profile; and
provide data for rendering the viewer environment on the television device of the viewer, the viewer environment including the customization aspects associated with the personalization data.
